(19) United States
(12) Patent Application Publication
(10) Pub. No.: US 2025/0141548 A1
(43) Pub. Date: May 1, 2025

(54) COMMUNICATION CONTROL DEVICE, COMMUNICATION DEVICE, COMMUNICATION CONTROL METHOD, AND RECORDING MEDIUM

(71) Applicant: NEC Corporation, Minato-ku, Tokyo (JP)

(72) Inventors: Koya TAKATA, Tokyo (JP); Hisashi Mizumoto, Tokyo (JP); Fujio Okumura, Kanagawa (JP)

(73) Assignee: NEC Corporation, Minato-ku, Tokyo (JP)

(21) Appl. No.: 18/689,534

(22) PCT Filed: Sep. 21, 2021
(86) PCT No.: PCT/JP2021/034512

§ 371 Date: Mar. 6, 2024

(51) Int. Cl. H04B 10/114; H04B 10/116

(52) U.S. Cl. CPC H04B 10/1141; H04B 10/116

(57) ABSTRACT

A communication control device that includes a light transmission condition generation unit that generates a light transmission condition for transmitting the first spatial light signal including the transmission signal toward a first address, a light transmission control unit that controls a light transmitting device to transmit the first spatial light signal toward the first address, a signal acquisition unit that acquires a reception signal included in the second spatial light signal that has received the second spatial light signal, a signal analysis unit that analyzes the reception signal and extracts a second address in a second transmission coordinate system, the second address being included in the reception signal, and a signal generation unit that generates the transmission signal including the first address, generate the transmission signal including the first address and the second address according to a result of analyzing the reception signal, and output the generated transmission signal.

### TECHNICAL FIELD

The present disclosure relates to a communication control device and the like used for optical spatial communication using a light signal propagating in a space.

### BACKGROUND ART

In optical spatial communication, a light signal (hereinafter, also referred to as a spatial light signal) propagating in space is transmitted and received without using a medium such as an optical fiber. In general optical spatial communication, communication is not established between a light transmission side and a light reception side of a spatial light signal at a stage of searching for a communication target. Therefore, in general spatial light communication, communication cannot be established unless it is detected on the light transmission side that the spatial light signal transmitted from the light transmission side is received on the light reception side.

PTL 1 discloses a spatial light communication system that performs bidirectional data communication using an optical beam. The system of PTL 1 detects and communicates with a communication partner using photodiodes disposed two-dimensionally. In the system of PTL 1, first, in order to notify the communication target of its own position, the transmission/reception device on the hub side emits intensity-modulated diffused light toward a wide range. The transmission/reception device on the node side generates a two-dimensional image in the image sensor operation mode in order to detect the position of the hub. The transmission/reception device on the node side detects the position of the hub on the generated two-dimensional image. The transmission/reception device on the node side determines the position and the number of pixels related to the position of the hub detected on the two-dimensional image, and switches the selected photodiode to the high speed communication operation mode. Then, the transmission/reception device on the node side emits diffused light that blinks at a predetermined frequency in order to notify the communication partner of its position. The transmission/reception device on the hub side detects the position of the transmission/reception device on the node side in an image sensor operation mode similar to that of the transmission/reception device on the node side. Thereafter, a communication path between the hub and the node is established by the spiral scan process by the transmission/reception device on the hub side and the peak detection process by the transmission/reception device on the node side.

### CITATION LIST

### Patent Literature

PTL 1: JP 2004-235899 A

### SUMMARY OF INVENTION

### Technical Problem

In the method of PTL 1, when a communication path is established, both communication devices on the hub side and the node side need to operate cooperatively. That is, in the method of PTL 1, the communication partner cannot be searched for unless the communication partner operates in the image sensor operation mode. In the method of PTL 1, in a case where a projection image of a communication partner is detected across a plurality of pixels on a two-dimensional image, the position of the communication partner is determined based on the centers of gravity of the plurality of pixels. Therefore, in the method of PTL 1, there is a case where communication with a communication partner cannot be established in a situation where a two-dimensional image cannot be generated.

An object of the present disclosure is to provide a communication control device or the like capable of establishing communication with a communication target in an any situation.

### Solution to Problem

A communication control device according to an aspect of the present disclosure controls a light transmitting device transmitting a first spatial light signal and a light receiving device receiving a second spatial light signal transmitted from a communication target, the communication control device includes a light transmission condition generation unit that generates, according to a transmission signal, a light transmission condition for transmitting the first spatial light signal including the transmission signal toward a first address in a first transmission coordinate system, a light transmission control unit that controls the light transmitting device in such a way as to transmit the first spatial light signal toward the first address based on the light transmission condition, a signal acquisition unit that acquires a reception signal included in the second spatial light signal from the light receiving device that has received the second spatial light signal, a signal analysis unit that analyzes the reception signal acquired by the signal acquisition unit and extracts a second address in a second transmission coordinate system, the second address being included in the reception signal, and a signal generation unit that generates the transmission signal including the first address, generate the transmission signal including the first address and the second address according to a result of analyzing the reception signal, and output the generated transmission signal to the light transmission condition generation unit.

A communication control method according to an aspect of the present disclosure includes controlling a light transmitting device transmitting a first spatial light signal and a light receiving device receiving a second spatial light signal transmitted from a communication target, the method executed by a computer includes generating, according to a transmission signal, a light transmission condition for transmitting the first spatial light signal including the transmission signal toward a first address in a first transmission coordinate system, controlling the light transmitting device in such a way as to transmit the first spatial light signal toward the first address based on the light transmission condition, acquiring a reception signal included in the second spatial light signal from the light receiving device that has received the second spatial light signal, extracting a second address in a second transmission coordinate system, the second address being included in the reception signal, by analyzing the acquired reception signal, and generating the transmission signal including the first address and generating the transmission signal including the first address and the second address according to a result of analyzing the reception signal.

A program according to an aspect of the present disclosure controls a light transmitting device transmitting a first spatial light signal and a light receiving device receiving a second spatial light signal transmitted from a communication target, the program causes a computer to execute the processing of generating, according to a transmission signal, a light transmission condition for transmitting the first spatial light signal including the transmission signal toward a first address in a first transmission coordinate system, controlling the light transmitting device in such a way as to transmit the first spatial light signal toward the first address based on the light transmission condition, acquiring a reception signal included in the second spatial light signal from the light receiving device that has received the second spatial light signal, extracting a second address in a second transmission coordinate system, the second address being included in the reception signal, by analyzing the acquired reception signal, and generating the transmission signal including the first address and generating the transmission signal including the first address and the second address according to a result of analyzing the reception signal.

### Advantageous Effects of Invention

According to the present disclosure, it is possible to provide a communication control device or the like capable of establishing communication with a communication target in an any situation.

### BRIEF DESCRIPTION OF DRAWINGS

FIG. 1 is a block diagram illustrating an example of a configuration of a communication device according to a first example embodiment.

FIG. 2 is a conceptual diagram for describing a transmission coordinate system set in a scan area of the communication device according to the first example embodiment.

FIG. 3 is a conceptual diagram illustrating an example in which a spatial light signal (primary scan signal) is transmitted from the communication device according to the first example embodiment.

FIG. 4 is a conceptual diagram illustrating an example in which a spatial light signal (secondary scan signal) is transmitted from the communication device according to the first example embodiment.

FIG. 5 is a conceptual diagram illustrating an example of a configuration of a light transmitting device included in the communication device according to the first example embodiment.

FIG. 6 is a conceptual diagram illustrating an example of a pattern set in a modulation part of a spatial light modulator of a light transmitting device included in the communication device according to the first example embodiment.

FIG. 7 is a block diagram illustrating an example of a configuration of a light receiving device included in the communication device according to the first example embodiment.

FIG. 8 is a block diagram illustrating an example of a configuration of a communication control device included in the communication device according to the first example embodiment.

FIG. 9 is a conceptual diagram for describing an example of a communication establishment procedure by the communication device according to the first example embodiment.

FIG. 10 is a conceptual diagram for describing an example of a communication establishment procedure by the communication device according to the first example embodiment.

FIG. 11 is a conceptual diagram for describing an example of a communication establishment procedure by the communication device according to the first example embodiment.

FIG. 12 is a conceptual diagram for describing an example of a communication establishment procedure by the communication device according to the first example embodiment.

FIG. 13 is a conceptual diagram for describing an example of a communication establishment procedure by the communication device according to the first example embodiment.

FIG. 14 is a conceptual diagram illustrating an example in which a plurality of spatial light signals transmitted from a communication target toward a plurality of scan addresses is received by the communication device according to the first example embodiment.

FIG. 15 is a conceptual diagram illustrating an example of reception intensity of a plurality of spatial light signals transmitted from a communication target toward a plurality of scan addresses by the communication device according to the first example embodiment.

FIG. 16 is a conceptual diagram illustrating an example in which a spatial light signal transmitted from a communication target toward a single scan address is received by the communication device according to the first example embodiment.

FIG. 17 is a conceptual diagram for describing detailed scanning performed by a communication target in response to a request from the communication device according to the first example embodiment.

FIG. 18 is a conceptual diagram for describing an example in which the communication device according to the first example embodiment scans a plurality of communication targets.

FIG. 19 is a block diagram illustrating an example of a configuration of a communication device according to the second example embodiment.

FIG. 20 is a block diagram illustrating an example of a configuration of a light receiving device of a communication device according to a second example embodiment.

FIG. 21 is a conceptual diagram for describing an example of a trace of light received by the light receiving device of the communication device according to the second example embodiment.

FIG. 22 is a block diagram illustrating an example of a configuration of a reception circuit included in the light receiving device of the communication device according to the second example embodiment.

FIG. 23 is a conceptual diagram for describing an example in which the communication device according to the second example embodiment scans a plurality of communication targets.

FIG. 24 is a block diagram illustrating an example of a configuration of a communication device according to a third example embodiment.

FIG. 25 is a conceptual diagram illustrating an example of a configuration of a transmission device included in the communication device according to the third example embodiment.

FIG. 26 is a conceptual diagram illustrating an example of a configuration of a transmission device included in the communication device according to the third example embodiment.

FIG. 27 is a conceptual diagram illustrating an example of an image formed by projection light projected by the transmission device included in the communication device according to the third example embodiment.

FIG. 28 is a conceptual diagram for describing an example in which the communication device according to the third example embodiment communicates with a plurality of communication targets.

FIG. 29 is a block diagram illustrating an example of a configuration of a communication control device according to a fourth example embodiment.

FIG. 30 is a block diagram illustrating an example of a hardware configuration that executes control and processing according to each example embodiment.

### EXAMPLE EMBODIMENT

Hereinafter, embodiments of the present invention will be described with reference to the drawings. However, the example embodiments described below have technically preferable limitations for carrying out the present invention, but the scope of the present invention is not limited to the following. In all the drawings used in the following description of the example embodiment, the same reference numerals are given to the same parts unless there is a particular reason. In the following example embodiments, repeated description of similar configurations and operations may be omitted.

In all the drawings used for description of the following example embodiments, the directions of the arrows in the drawings are merely examples, and do not limit the directions of light and signals. A line indicating a trace of light in the drawings is conceptual, and does not accurately indicate an actual traveling direction or state of light. For example, in the drawings, a change in a traveling direction or a state of light due to refraction, reflection, diffraction, diffusion, or the like at an interface between air and a substance may be omitted, or a light flux may be expressed by one line.

### First Example Embodiment

First, a communication device according to a first example embodiment will be described with reference to the drawings. The communication device according to the present example embodiment performs optical spatial communication for transmitting and receiving light signals (hereinafter, also referred to as a spatial light signal) propagating in a space without using a medium such as an optical fiber.

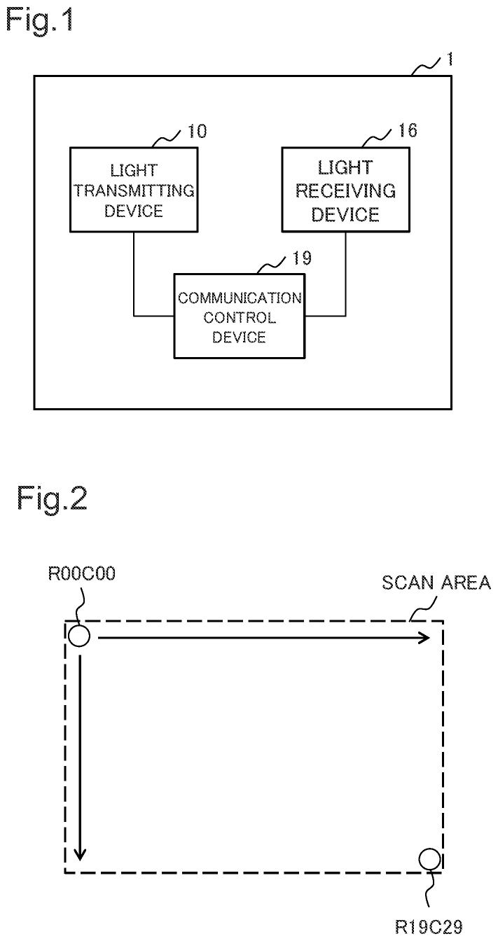

FIG. 1 is a block diagram illustrating an example of a configuration of a communication device 1 of the present example embodiment. The communication device 1 of the present example embodiment includes a light transmitting device 10, a light receiving device 16, and a communication control device 19. Hereinafter, an example in which the communication device 1 searches for (scans) a communication target will be described. Thereafter, the light transmitting device 10, the light receiving device 16, and the communication control device 19 will be individually described.

### [Scan]

First, an example of scanning of a communication target by the communication device 1 will be described with reference to the drawings. An example of scanning of a communication target in which two communication devices 1 (communication device 1A and communication device 1B) scan transmit and receive spatial light signals with each other will be described. The communication device 1A and the communication device 1B scan each other and establish communication. Hereinafter, an example in which both the communication device 1A and the communication device 1B operate in the scan mode will be described. Scanning of the communication target is performed at the time of startup of the communication network including the plurality of communication devices 1 or at a predetermined time. The time point at which the communication target is scanned is not particularly limited.

FIG. 2 is a conceptual diagram for describing a scan area of the communication device 1. In FIG. 2, C represents a column, and R represents a row. In the example of FIG. 2, a coordinate system (also referred to as a transmission coordinate system) in which the upper left of the scan area is the origin (R00C00) and the lower right is the end point (R19C29) is set. Position coordinates (also referred to as a scan address) of the target when the spatial light signal is transmitted are set in the scan area. 20 rows of R00, R01, R02, . . . , and R19 are set in the vertical direction of the scan area. 30 columns of C00, C01, C02, . . . , and C29 are set in the lateral direction of the scan area. In the example of FIG. 2, 20 rows×30 columns=600 scan addresses are set in the scan area. Hereinafter, an example in which a scan area is set for each communication device 1 will be described. A common scan area may be set among the communication devices 1.

The communication device 1 transmits a spatial light signal with a scan address in a scan area of the device as a target. In the scanning stage, the communication device 1 sequentially transmits the spatial light signals for scanning toward a plurality of scan addresses in the scan area. The light transmission method of the spatial light signal for scanning by the light transmitting device 10 is not particularly limited. For example, the light transmitting device 10 transmits the spatial light signal for scanning in a row scanning method of sequentially performing one-dimensional scanning in the lateral direction for each row in the transmission coordinate system. For example, the light transmitting device 10 transmits a spatial light signal for scanning in a column scanning system in which one-dimensional scanning in the longitudinal direction is sequentially performed for each column in the transmission coordinate system. For example, when more detailed scanning is performed, the spatial light signal may be transmitted toward position coordinates between scan addresses in the scan area. For example, in a case where mutual communication with a communication target for which communication has been established is performed, a spatial light signal is transmitted in a direction in which the communication target is located with a scan address in a scan area as a reference.

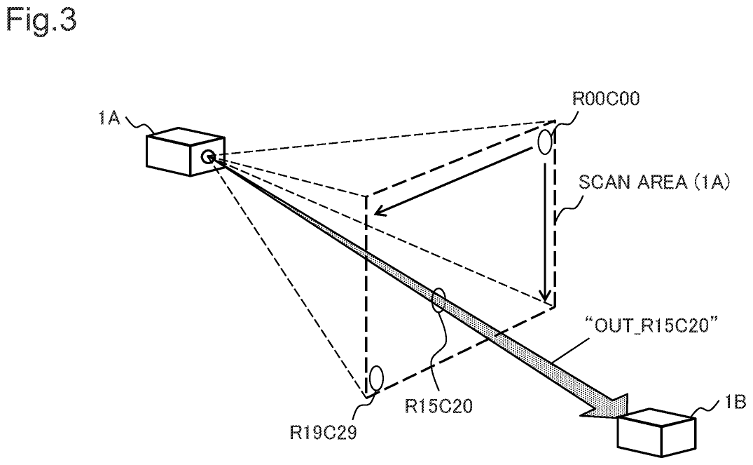

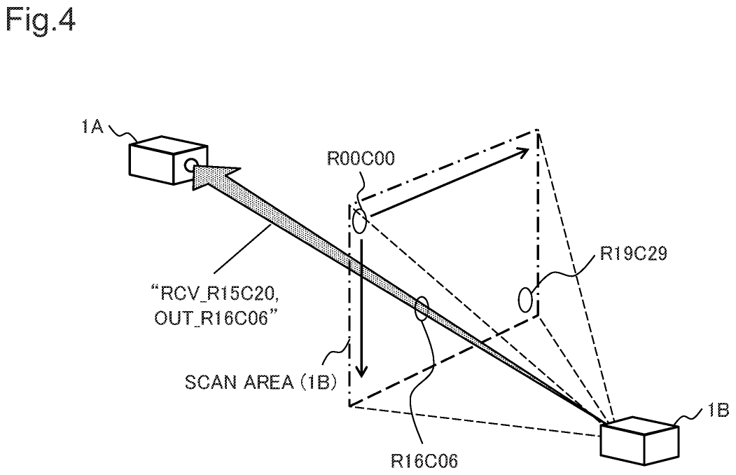

Next, transmission and reception of spatial light signals between the two communication devices 1 will be described with reference to the drawings. FIGS. 3 to 4 are conceptual diagrams illustrating an example of transmission and reception of a spatial light signal between the communication device 1A and the communication device 1B. In the examples of FIGS. 3 to 4, an individual scan area is set for each of the communication device 1A and the communication device 1B. An individual transmission coordinate system is set in the scan area of each of the communication device 1A and the communication device 1B.

FIG. 3 is a conceptual diagram illustrating a state in which a spatial light signal (primary scan signal) transmitted by the communication device 1A is received by the communication device 1B. The transmission coordinate system of the scan area in FIG. 3 is the transmission coordinate system (dashed rectangle) of the communication device 1A. At the stage of FIG. 3, the communication device 1B detects the communication device 1A. On the other hand, in the stage of FIG. 3, the communication device 1A does not recognize the communication device 1B.

The communication device 1A transmits a scanning spatial light signal (primary scan signal) including a target scan address (transmission coordinate system of the communication device 1A). The primary scan signal transmitted by the communication device 1A includes information “OUT_R15C20”. The information “OUT_R15C20” indicates that the communication device 1A has transmitted the primary scan signal toward the scan address “R15C20” of the communication device 1A in the transmission coordinate system. The primary scan signal may include information other than the scan address. The information that is included in the primary scan signal but that is not the transmission position coordinates of the scan address is not particularly limited.

The communication device 1B receives the primary scan signal transmitted from the communication device 1A. The communication device 1B detects the communication device 1A with the received primary scan signal. The communication device 1B identifies the scan address (transmission coordinate system of the communication device 1A) of the target to which the communication device 1A has transmitted the primary scan signal based on the received primary scan signal.

Upon receiving the primary scan signal from the communication device 1A, the communication device 1B transmits a scanning spatial light signal (secondary scan signal) including a response to the primary scan signal. The secondary scan signal includes a scan address (transmission coordinate system of the communication device 1A) related to a direction in which the primary scan signal is transmitted, the scan address being included in the received primary scan signal. The secondary scan signal includes the scan address (the transmission coordinate system of the communication device 1B) of the target of the secondary scan signal. The secondary scan signal may include information other than the scan address. The information that is included in the secondary scan signal but that is not the transmission position coordinates of the scan address is not particularly limited.

FIG. 4 is a conceptual diagram illustrating a state in which the secondary scan signal transmitted from the communication device 1B is received by the communication device 1A. The transmission coordinate system of the scan area in FIG. 4 is a transmission coordinate system of the communication device 1B (a rectangle of a one-dot chain line). The secondary scan signal transmitted by the communication device 1B includes information “RCV_R15C20, OUT_R16C06”. The information “RCV_R15C20” indicates that the primary scan signal transmitted toward the scan address “R15C20” of the communication device 1A in the transmission coordinate system is received. The information “OUT_R16C06” indicates that the secondary scan signal has been transmitted toward the scan address “OUT_R05C0” of the communication device 1B in the transmission coordinate system.

Upon receiving the secondary scan signal from the communication device 1B, the communication device 1A transmits a spatial light signal (primary communication establishment signal) for establishing communication including a response to the secondary scan signal. The communication device 1A identifies a scan address (transmission coordinate system of the communication device 1A) of a target of the primary scan signal received by the communication device 1B based on information included in the secondary scan signal transmitted from the communication device 1B. The communication device 1A transmits a primary communication establishment signal toward the identified scan address (transmission coordinate system of the communication device 1A).

The primary communication establishment signal includes information making a notification that the secondary scan signal transmitted from the communication device 1B is received. For example, the communication device 1A transmits a primary communication establishment signal including information “HIT_R15C20, RCV_R16C06”. The information “HIT_R15C20” indicates that the communication device 1A has received the secondary scan signal as a response to the primary scan signal transmitted to the scan address “R15C20” (the transmission coordinate system of the communication device 1A). The information “RCV_R16C06” indicates that the communication device 1B has received the secondary scan signal transmitted to the scan address “R16C06” (the transmission coordinate system of the communication device 1B). The communication device 1A transmits the primary communication establishment signal toward the scan address “R15C20” (the transmission coordinate system of the communication device 1A) where the communication device 1B is located. The primary communication establishment signal transmitted from the communication device 1A is received by the communication device 1B.

The communication device 1B receives the primary communication establishment signal transmitted from the communication device 1A. Upon receiving the primary communication establishment signal from the communication device 1A, the communication device 1B transmits a spatial light signal (secondary communication establishment signal) for establishing communication, the spatial light signal including a response to the primary communication establishment signal.

The secondary communication establishment signal includes information making a notification that the primary communication establishment signal transmitted from the communication device 1A is received. For example, the communication device 1A transmits a primary communication establishment signal including information “HIT_R16C06, RCV_R15C20”. The information “HIT_R16C06” indicates that the communication device 1B has received the primary communication establishment signal as a response to the secondary scan signal transmitted to the scan address “R16C06” (the transmission coordinate system of the communication device 1B). The information “RCV_R15C20” indicates that the communication device 1A has received the primary communication establishment signal transmitted to the scan address “R15C20” (the transmission coordinate system of the communication device 1A). The communication device 1B transmits the secondary communication establishment signal toward the scan address “R16C06” (the transmission coordinate system of the communication device 1B) where the communication device 1A is located. The secondary communication establishment signal transmitted from the communication device 1B is received by the communication device 1A.

When the communication device 1B receives the primary communication establishment signal transmitted from the communication device 1A and the communication device 1A receives the secondary communication establishment signal transmitted from the communication device 1B, communication between the communication device 1A and the communication device 1B is established. The communication between the communication device 1A and the communication device 1B after the communication between the communication device 1A and the communication device 1B is established is not particularly limited.

### [Light Transmitting Device]

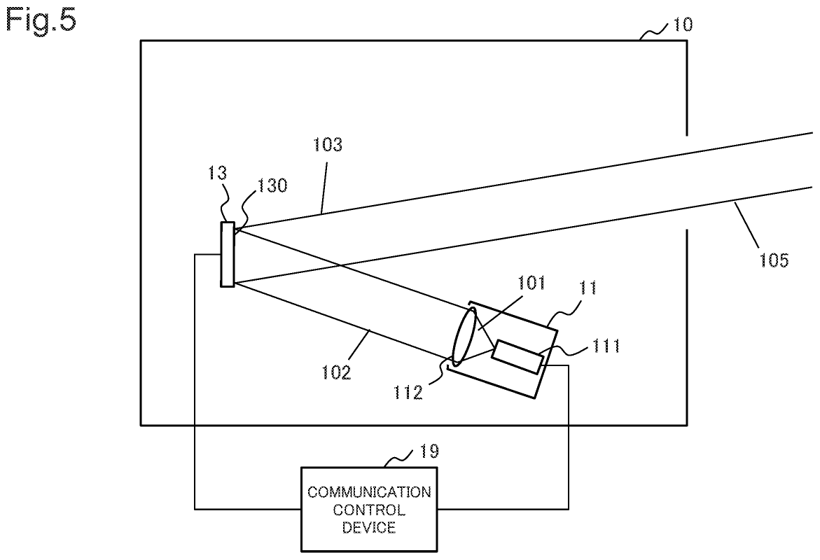

Next, a configuration of the light transmitting device 10 will be described with reference to the drawings. FIG. 5 is a conceptual diagram illustrating an example of a configuration of the light transmitting device 10. The light transmitting device 10 includes a light source 11 and a spatial light modulator 13. The light source 11 includes a light emitter 111 and a lens 112. FIG. 5 is a side view of the internal configuration of the light transmitting device 10 when viewed from the lateral direction. FIG. 5 is conceptual, and does not accurately represent the positional relationship between the components, the traveling direction of light, and the like.

The light emitter 111 emits a laser beam 101 in a predetermined wavelength band toward the lens 112 under the control of the communication control device 19. The wavelength of the laser beam 101 emitted from the light emitter 111 is not particularly limited, and may be selected according to the application. For example, the light emitter 111 emits the laser beam 101 in the visible or infrared wavelength band. For example, in the case of near infrared rays of 800 to 900 nanometers (nm), the laser class can be increased, so that the sensitivity can be improved by about one digit as compared with other wavelength bands. For example, a high-output laser beam source can be used for infrared rays in a wavelength band of 1.55 micrometers (μm). As an infrared laser beam source in a wavelength band of 1.55 μm, an aluminum gallium arsenide phosphorus (AlGaAsP)—based laser beam source, an indium gallium arsenide (InGaAs)—based laser beam source, or the like can be used. The longer the wavelength of the laser beam 101 is, the larger the diffraction angle can be made and the higher the energy can be set.

The lens 112 is disposed in such a way that the laser beam 101 emitted from the light emitter 111 is radiated in accordance with the size of a modulation part 130 of the spatial light modulator 13. The radiation range of the laser beam 101 emitted from the light emitter 111 is adjusted by the lens 112, and the laser beam is emitted from the light source 11. Light 102 emitted from the light source 11 travels toward the modulation part 130 of the spatial light modulator 13.

The spatial light modulator 13 includes the modulation part 130. The modulation part 130 is irradiated with the light 102. The light 102 is modulated by modulation part 130 and emitted as modulated light 103. A pattern (also referred to as a phase image) related to an image displayed by projection light 105 is set to the modulation part 130 under the control of the communication control device 19. When the spatial light modulator 13 is used, a high-order image is generated as in the diffraction grating because the diffraction phenomenon is used. For example, a mechanism for removing high-order light may be disposed on an optical path of the modulated light 103 or the projection light 105. The modulated light 103 includes 0th-order light. For example, a mechanism for removing 0th-order light may be disposed on an optical path of the modulated light 103 or the projection light 105.

The spatial light modulator 13 is achieved by a spatial light modulator including ferroelectric liquid crystal, homogeneous liquid crystal, vertical alignment liquid crystal, or the like. For example, the spatial light modulator 13 can be achieved by liquid crystal on silicon (LCOS). The spatial light modulator 13 may be achieved by a micro electro mechanical system (MEMS). In the phase modulation type spatial light modulator 13, the energy can be concentrated on the portion of the image by operating to sequentially switch the portion on which the projection light 105 is projected. Therefore, in the case of using the phase modulation type spatial light modulator 13, when the output of the light source 11 is the same, the image can be displayed brighter than that of other methods.

The modulation part 130 of the spatial light modulator 13 is divided into a plurality of regions (also referred to as tiling). For example, the modulation part 130 is divided into rectangular regions (also referred to as tiles) having a desired aspect ratio. Each of the plurality of tiles includes a plurality of pixels. A phase image is tiled to each of the plurality of tiles allocated to the modulation part 130. For example, a phase image generated in advance is set in each of the plurality of tiles. A phase image related to an image to be projected is set to each of the plurality of tiles.

When the modulation part 130 is irradiated with the light 102 in a state where the phase images are set for the plurality of tiles, the modulated light 103 that forms an image related to the phase image of each tile is emitted. As the number of tiles set in the modulation part 130 increases, a clear image can be displayed. When the number of pixels of each tile decreases, the resolution decreases. Therefore, the size and number of tiles set in the modulation part 130 are set according to the application.

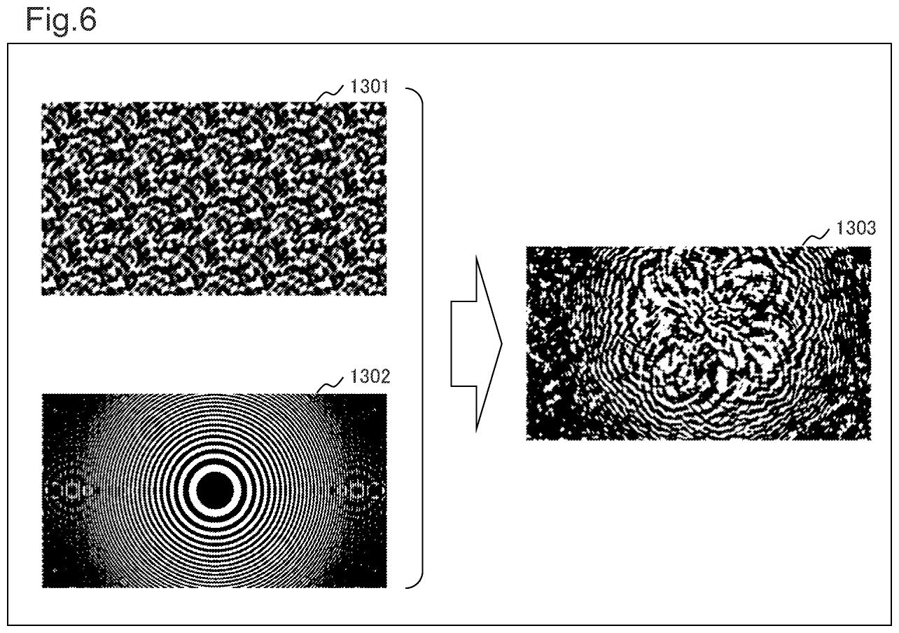

FIG. 6 is a conceptual diagram illustrating an example of a pattern set in the modulation part 130 of the spatial light modulator 13. A composite image 1303 is set in the modulation part 130. The composite image 1303 is a pattern obtained by combining a phase image 1301 for forming a desired image with a virtual lens image 1302 for condensing light for forming a desired image. As in diffraction, the wavefront of light can be controlled by phase control. When the phase changes to a spherical shape, a spherical difference is generated in the wavefront, and a lens effect is generated. The virtual lens image 1302 changes the phase of the light 102 with which the modulation part 130 of the spatial light modulator 13 is irradiated into a spherical shape, and generates a lens effect of condensing the light at a position of a predetermined focal distance.

For example, a curved surface mirror having a curved reflecting surface that reflects and enlarges the modulated light 103 modulated by the modulation part 130 of the spatial light modulator 13 may be disposed at the position of the condensing point of the virtual lens image 1302. The curved surface mirror is disposed with a curved reflecting surface facing the modulation part 130 of the spatial light modulator 13. The curved surface mirror reflects the modulated light 103 modulated by the modulation part 130 of the spatial light modulator 13 on a curved reflecting surface. The modulated light 103 reflected by the reflecting surface of the curved surface mirror is projected as the projection light 105. The projection light 105 is enlarged and projected at an enlargement ratio related to the curvature of the reflecting surface. For example, the image collected by the virtual lens image 1302 is formed on the reflecting surface of the curved surface mirror. For example, the composite image 1303 generated in advance may be stored in a storage unit (not illustrated). FIG. 6 is an example, and does not limit the patterns of the phase image 1301, the virtual lens image 1302, and the composite image 1303.

For example, a shielder that shields unnecessary light components included in the modulated light 103 may be disposed on the optical path of the modulated light 103 or the projection light 105. The shielder is a frame that shields unnecessary light components included in the modulated light 103 and defines an outer edge of a display region of the projection light 105. The shielder transmits light that forms a desired image and shields unwanted light components. For example, the shielder is an aperture in which an opening is formed in a portion through which light forming a desired image passes. For example, the shielder shields a ghost image derived from high-order light included in the modulated light 103.

For example, a 0th-order light remover for removing 0th-order light may be disposed on the optical path of the modulated light 103 or the projection light 105. For example, the 0th-order light remover includes a light absorbing element supported by an element that supports the light absorbing element. The light absorbing element is fixed on the optical path of the 0th-order light included in the modulated light 103 and the projection light 105 by the support element. For example, the support element is made of a material such as glass or plastic through which the modulated light 103 or the projection light 105 passes. For example, a black body such as carbon is used for the light absorbing element. When the wavelength of the laser beam 101 to be used is fixed, it is preferable to use a light absorbing element made of a material that selectively absorbs light having the wavelength of the laser beam 101.

The light transmitting device 10 transmits different spatial light signals between a scanning stage in which a spatial light signal for scanning a communication target is transmitted and a communication stage in which communication with the communication target is established. The spatial light signal transmitted in the communication stage is not particularly limited. The spatial light signal transmitted in the scanning stage is as described above with reference to FIGS. 2 to 4.

### [Light Receiving Device]

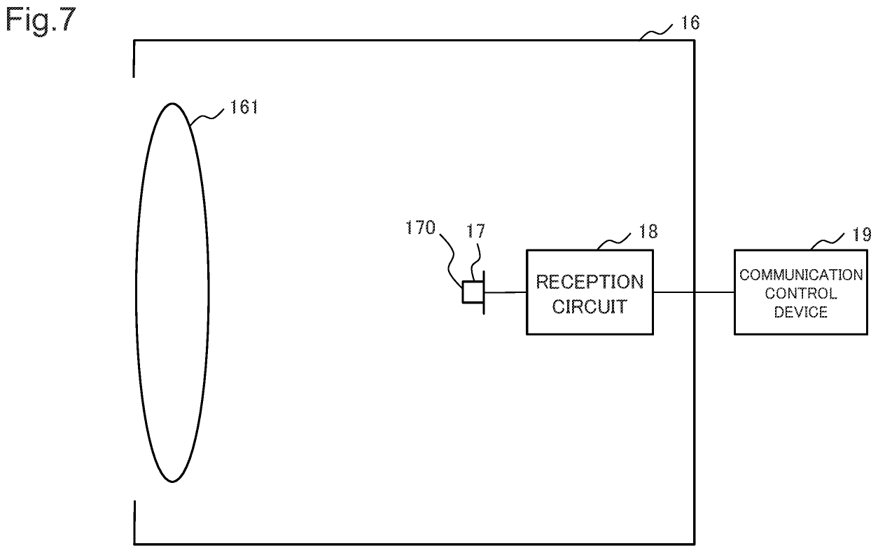

Next, a configuration of the light receiving device 16 will be described with reference to the drawings. FIG. 7 is a conceptual diagram for describing an example of a configuration of the light receiving device 16. The light receiving device 16 includes a concentrator 161, a light receiving element 17, and a reception circuit 18. FIG. 7 is a plan view of the internal configuration of the light receiving device 16 when viewed from above. The position of the reception circuit 18 is not particularly limited. The reception circuit 18 may be disposed inside the light receiving device 16 or may be disposed outside the light receiving device 16. The function of the reception circuit 18 may be included in the communication control device 19.

The concentrator 161 is an optical element that collects a spatial light signal arriving from the outside. The spatial light signal is incident on the incident face of the concentrator 161. The light signal collected by the concentrator 161 is collected toward a light receiving unit 170 of the light receiving element 17. For example, the concentrator 161 is a lens that collects an incident spatial light signal. For example, the concentrator 161 is a light beam control element that guides the incident spatial light signal toward the light receiving unit 170 of the light receiving element 17. For example, the concentrator 161 may have a configuration in which a lens or a light beam control element is combined. The configuration of the concentrator 161 is not particularly limited as long as the spatial light signal can be condensed toward the region where the light receiving element 17 is disposed. For example, a mechanism for guiding the light signal collected by the concentrator 161 toward the light receiving unit 170 of the light receiving element 17 may be added.

The light receiving element 17 is disposed behind the concentrator 161. The light receiving element 17 is disposed in such a way that the emission surface of the concentrator 161 and the light receiving unit 170 face each other. The light receiving element 17 includes the light receiving unit 170 that receives the light signal collected by the concentrator 161. The light signal collected by the concentrator 161 is received by the light receiving unit 170 of the light receiving element 17. The light receiving element 17 converts the received light signal into an electric signal (hereinafter, also referred to as a signal). The light receiving element 17 outputs the converted signal to the reception circuit 18.

The light receiving element 17 receives light in a wavelength region of the spatial light signal to be received. For example, the light receiving element 17 has sensitivity to light in the visible region. For example, the light receiving element 17 has sensitivity to light in an infrared region. The light receiving element 17 is sensitive to light having a wavelength in a 1.5 μm (micrometer) band, for example. The wavelength band of light to which the light receiving element 17 has sensitivity is not limited to the 1.5 μm band. The wavelength band of the light received by the light receiving element 17 can be set to any band in accordance with the wavelength of the spatial light signal to be received. The wavelength band of the light received by the light receiving element 17 may be set to, for example, a 0.8 μm band, a 1.55 μm band, or a 2.2 μm band. The wavelength band of the light received by the light receiving element 17 may be, for example, a band of 0.8 to 1 μm. A shorter wavelength band is advantageous for optical spatial communication during rainfall because absorption by moisture in the atmosphere is small. When the light receiving element 17 is saturated with intense sunlight, the light receiving element 17 cannot read the light signal derived from the spatial light signal. Therefore, a color filter that selectively passes the light of the wavelength band of the spatial light signal may be installed before the light receiving element 17.

For example, the light receiving element 17 can be achieved by an element such as a photodiode or a phototransistor. For example, the light receiving element 17 is achieved by an avalanche photodiode. The light receiving element 17 achieved by the avalanche photodiode can support high speed communication. The light receiving element 17 may be achieved by an element other than a photodiode, a phototransistor, or an avalanche photodiode as long as a light signal can be converted into an electric signal. In order to improve the communication speed, the light receiving unit of the light receiving element 17 is preferably as small as possible. For example, the light receiving unit of the light receiving element 17 has a square light receiving surface having a side of about 5 mm (mm). For example, the light receiving unit of the light receiving element 17 has a circular light receiving surface having a diameter of about 0.1 to 0.3 mm. The size and shape of the light receiving unit of the light receiving element 17 may be selected according to the wavelength band, the communication speed, and the like of the spatial light signal.

For example, a light receiving filter (not illustrated) may be disposed before the light receiving element 17. The light receiving filter is disposed in association with the light receiving unit 170 of the light receiving element 17. For example, the light receiving filter is disposed to overlap the light receiving unit 170 of the light receiving element 17. For example, the light receiving filter may be selected according to the polarization state of the spatial light signal to be received. For example, when the spatial light signal of the light receiving target is linearly polarized light, the light receiving filter includes a ½ wavelength plate. For example, when the spatial light signal of the light receiving target is circularly polarized light, the light receiving filter includes a ¼ wavelength plate. The polarization state of the light signal having passed through the light receiving filter is converted according to the polarization characteristic of the light receiving filter.

The reception circuit 18 acquires a signal output from the light receiving element 17. The reception circuit 18 amplifies the signal from the light receiving element 17. The reception circuit 18 decodes the amplified signal. The signal decoded by the reception circuit 18 is used for any purpose. The use of the signal decoded by the reception circuit 18 is not particularly limited.

### [Communication Control Device]

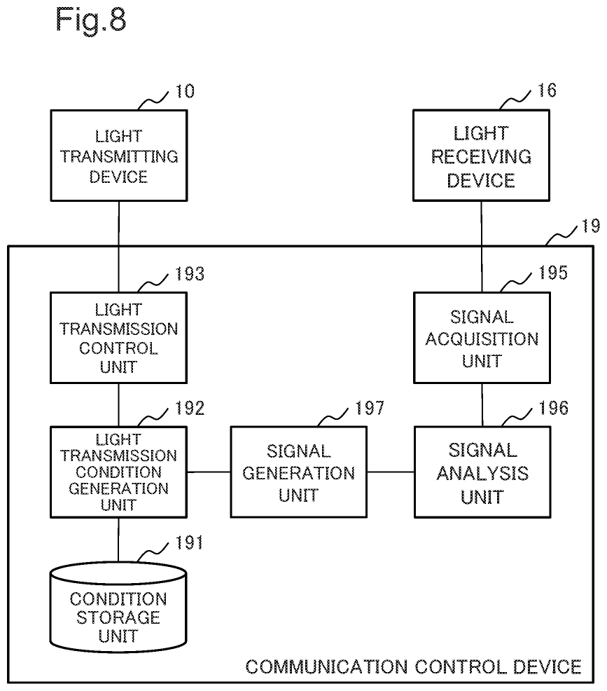

Next, a configuration of the communication control device 19 will be described with reference to the drawings. FIG. 8 is a block diagram for describing an example of a configuration of the communication control device 19. The communication control device 19 includes a condition storage unit 191, a light transmission condition generation unit 192, a light transmission control unit 193, a signal acquisition unit 195, a signal analysis unit 196, and a signal generation unit 197. For example, the communication control device 19 is achieved by a microcomputer including a processor and a memory. The communication control device 19 may be mounted on a server or a cloud connected to the light transmitting device 10 or the light receiving device 16 via a network.

The condition storage unit 191 stores a pattern (also referred to as a phase image) related to the projection light 105 to be transmitted to the light transmitting device 10. The pattern stored in the condition storage unit 191 is set in the modulation part 130 of the spatial light modulator 13. The condition storage unit 191 stores projection conditions including a light source control condition for controlling the light source 11 of the light transmitting device 10 and a modulator control condition for controlling the spatial light modulator 13 of the light transmitting device 10. The light source control condition is a condition including a timing at which the laser beam 101 is emitted from the light source 11 of the light transmitting device 10. The modulator control condition is a condition for setting a pattern in the modulation part 130 of the spatial light modulator 13. By coordinating the light source control condition and the modulator control condition, the projection light 105 related to the pattern set in the modulation part 130 of the spatial light modulator 13 is projected.

The light transmission condition generation unit 192 acquires a signal from the signal generation unit 197. The light transmission condition generation unit 192 generates a light transmission condition for transmitting information included in the acquired signal based on the condition stored in the condition storage unit 191. For example, the light transmission condition generation unit 192 selects a pattern (phase image) for transmitting the information included in the acquired signal based on the projection condition stored in the condition storage unit 191. For example, the light transmission condition generation unit 192 generates a light transmission condition for setting a pattern (phase image) related to an image projected for transmitting information included in the acquired signal to the modulation part 130 of the spatial light modulator 13. For example, the light transmission condition generation unit 192 generates a light transmission condition for setting a phase image related to a projected image in the modulation part 130 of the spatial light modulator 13 in accordance with the aspect ratio of tiling set in the modulation part 130 of the spatial light modulator 13.

The light transmission condition generation unit 192 generates a light transmission condition for transmitting the primary scan signal, the secondary scan signal, the primary communication establishment signal, the secondary communication establishment signal, and the communication signal. The primary scan signal and the secondary scan signal are signals for scanning a communication target. The primary communication establishment signal and the secondary communication establishment signal are signals for establishing communication with the scanned communication target. The communication signal includes information to be transmitted to a communication target for which communication is established. For example, the light transmission condition generation unit 192 sets the light transmission condition for controlling blinking of the projection light 105 according to information added to the primary scan signal, the secondary scan signal, the primary communication establishment signal, the secondary communication establishment signal, and the communication signal.

When shifting to the scan mode, the light transmission condition generation unit 192 generates a light transmission condition for transmitting the primary scan signal. The primary scan signal is a signal for searching for a communication target. For the secondary scan signal, the primary communication establishment signal, and the secondary communication establishment signal, the light transmission condition is generated according to the signal generated by the signal generation unit 197. When the communication with the communication target is established and the mode shifts to the communication mode, the light transmission condition generation unit 192 generates the light transmission condition for transmitting the communication signal according to the signal generated by the signal generation unit 197.

The light transmission control unit 193 controls the light source 11 and the spatial light modulator 13 of the light transmitting device 10 based on the light transmission condition set by the light transmission condition generation unit 192. The light transmission control unit 193 sets a phase image related to the projected image in the modulation part 130 of the spatial light modulator 13 based on the light transmission condition. The light transmission control unit 193 causes the light source 11 to emit the light 102 in accordance with the timing at which the phase image is set in the modulation part 130. As a result, projection light 105 corresponding to a spatial light signal for scanning and communication is transmitted.

The light transmission control unit 193 drives the spatial light modulator 13 in such a way that a parameter that determines a difference between a phase of the light 102 with which the modulation part 130 of the spatial light modulator 13 is irradiated and a phase of the modulated light 103 reflected by the modulation part 130 changes. The parameter that determines the difference between the phase of the light 102 with which the modulation part 130 of the spatial light modulator 13 is irradiated and the phase of the modulated light 103 reflected by the modulation part 130 is, for example, a parameter regarding optical characteristics such as a refractive index and an optical path length. For example, the light transmission control unit 193 adjusts the optical characteristics of the modulation part 130 by changing the voltage applied to the modulation part 130 of the spatial light modulator 13. The phase distribution of the light 102 with which the modulation part 130 of the phase modulation type spatial light modulator 13 is irradiated is modulated according to the optical characteristics of the modulation part 130. The driving method of the spatial light modulator 13 by the light transmission control unit 193 is determined according to the modulation scheme of the spatial light modulator 13.

The light transmission control unit 193 drives the light emitter 111 of the light source 11 in a state where the phase image related to the image displayed by the projection light 105 is set in the modulation part 130. As a result, the modulation part 130 of the spatial light modulator 13 is irradiated with the light 102 emitted from the light source 11 in accordance with the timing at which the phase image is set in the modulation part 130 of the spatial light modulator 13. The light 102 with which the modulation part 130 of the spatial light modulator 13 is irradiated is modulated according to the phase image set in the modulation part 130 of the spatial light modulator 13. The modulated light 103 modulated by the modulation part 130 of the spatial light modulator 13 is projected as the projection light 105.

The signal acquisition unit 195 acquires the signal decoded by the light receiving device 16 from the light receiving device 16. The signal acquisition unit 195 acquires the signal to which the signal process has been applied by the light receiving device 16 from the light receiving device 16. The signal acquired by the signal acquisition unit 195 includes a scanned communication target or a response transmitted from a communication target in communication according to the spatial light signal transmitted from the communication device 1.

The signal analysis unit 196 analyzes the signal acquired by the signal acquisition unit 195. The signal analysis unit 196 analyzes information included in the signal according to the type of the signal. The types of signals include a primary scan signal, a secondary scan signal, a primary communication establishment signal, a secondary communication establishment signal, and a communication signal.

The primary scan signal is a spatial light signal for searching for a communication target. The signal analysis unit 196 acquires the primary scan signal transmitted from the communication target. The primary scan signal acquired by the signal analysis unit 196 includes the scan address (transmission coordinate system of the communication target) of the target of the primary scan signal. For example, the primary scan signal includes information “OUT_R15C20”. The information “OUT_R15C20” indicates that the communication target has transmitted the primary scan signal toward the scan address “R15C20” of the communication target in the transmission coordinate system. The signal analysis unit 196 outputs, to the signal generation unit 197, an instruction to generate a secondary scan signal to be transmitted to a communication target that is a light transmission source of the acquired primary scan signal.

The secondary scan signal is a spatial light signal for notifying the communication target of the light transmission source of the primary scan signal that the primary scan signal transmitted from the communication target has been received. The signal analysis unit 196 acquires the secondary scan signal transmitted from the communication target. The secondary scan signal acquired by the signal analysis unit 196 includes the scan address (the transmission coordinate system of the host device) of the target of the primary scan signal received by the communication target. The secondary scan signal includes a scan address (transmission coordinate system of the communication target) of the target of the secondary scan signal transmitted from the communication target. For example, the secondary scan signal includes information “OUT_R05C07, RCV_R15C20”. The information “OUT_R05C07” indicates that the communication target has transmitted the secondary scan signal toward the scan address “R05C07” of the communication target in the transmission coordinate system. The information “RCV_R15C20” indicates that the primary scan signal transmitted from the host device toward the scan address “R05C07” (the transmission coordinate system of the host device) is received by the communication target. Upon receiving the secondary scan signal, the signal analysis unit 196 outputs, to the signal generation unit 197, an instruction to generate a primary communication establishment signal transmitted to a light transmission source of the received secondary scan signal.

The primary communication establishment signal is a spatial light signal for notifying the communication target of the light transmission source of the secondary scan signal that the secondary scan signal transmitted from the communication target has been received. The signal analysis unit 196 acquires the primary communication establishment signal transmitted from the communication target. The primary communication establishment signal includes the scan address (transmission coordinate system of the communication target) of the secondary scan signal of the communication target. The primary communication establishment signal includes the scan address (the transmission coordinate system of the host device) of the target of the primary communication establishment signal. For example, the primary communication establishment signal includes information “HIT_R15C20, RCV_R08C10”. The information “HIT_R15C20” indicates the scan address “R15C20” (the transmission coordinate system of the communication target) of the target of the primary communication establishment signal transmitted by the communication target in response to the secondary scan signal transmitted from the host device. The information “RCV_R08C10” indicates that the secondary scan signal transmitted to the scan address “R08C10” of the communication target in the transmission coordinate system is received. Upon receiving the primary communication establishment signal, the signal analysis unit 196 outputs, to the signal generation unit 197, an instruction to generate a secondary communication establishment signal to be transmitted to the communication target of the light transmission source of the received primary communication establishment signal.

The secondary communication establishment signal is a spatial light signal for notifying the communication target of the light transmission source of the primary communication establishment signal that the primary communication establishment signal transmitted from the communication target has been received. The signal analysis unit 196 acquires the secondary communication establishment signal transmitted from the communication target. The secondary communication establishment signal includes the scan address (the transmission coordinate system of the host device) of the target of the primary communication establishment signal received by the communication target. The secondary communication establishment signal includes the scan address (transmission coordinate system of the communication target) of the target of the secondary communication establishment signal. For example, the secondary communication establishment signal includes information “HIT_R08C10, RCV_R15C20”. The information “HIT_R08C10” indicates that the secondary scan signal transmitted by the communication target to the scan address “R08C10” (transmission coordinate system of the communication target) is received by the host device. The information “RCV_R15C20” indicates that the primary communication establishment signal transmitted from the host device to the scan address “R15C20” (the transmission coordinate system of the host device) is received by the communication target. Upon receiving the secondary communication establishment signal, the signal analysis unit 196 outputs, to the signal generation unit 197, an instruction to generate a communication signal to be transmitted to the light transmission source of the received secondary communication establishment signal.

The communication signal is a spatial light signal transmitted and received between the communication devices 1 for which communication is established when a communication path for transmitting and receiving the spatial light signal is determined. The communication signal is transmitted and received between the communication devices 1 based on position coordinates identified by exchange of the primary scan signal, the secondary scan signal, the primary communication establishment signal, and the secondary communication establishment signal. The content of the communication signal is not particularly limited. Upon receiving the communication signal, the signal analysis unit 196 outputs, to the signal generation unit 197, an instruction to generate a communication signal to be transmitted to a light transmission source of the received communication signal.

The signal generation unit 197 generates a signal to be transmitted to the communication target. The signal generation unit 197 generates the primary scan signal, the secondary scan signal, the primary communication establishment signal, the secondary communication establishment signal, and the communication signal. The signal generation unit 197 outputs the generated signal to the light transmission condition generation unit 192. Each of the primary scan signal, the secondary scan signal, the primary communication establishment signal, the secondary communication establishment signal, and the communication signal generated by the signal generation unit 197 is as described above.

When shifting to the scan mode, the signal generation unit 197 generates a primary scan signal. The primary scan signal is a spatial light signal for searching for a communication target. The primary scan signal includes transmission position coordinates of the primary scan signal of the host device in the transmission coordinate system of the host device. For example, the signal generation unit 197 generates a primary scan signal including information “OUT_R01C03”. The information “OUT_R01C03” indicates that the host device has transmitted the primary scan signal toward the dot of the position coordinate “R01C03” in the transmission coordinate system of the host device. The signal generation unit 197 may be configured to generate the primary scan signal at a predetermined timing or time instead of an instruction from the signal analysis unit 196.

The signal generation unit 197 generates a secondary scan signal in accordance with an instruction from the signal analysis unit 196. The secondary scan signal is a signal for notifying the communication target of the light transmission source of the primary scan signal that the primary scan signal transmitted from the communication target has been received. The secondary scan signal includes the scan address (the transmission coordinate system of the host device) of the target of the secondary scan signal. The secondary scan signal includes the scan address (transmission coordinate system of the communication target) of the target of the primary scan signal transmitted by the communication target. For example, the signal generation unit 197 generates a secondary scan signal including information “OUT_R05C07, RCV_R15C20”. The information “RCV_R15C20” indicates that the communication target has received the primary scan signal transmitted toward the scan address “R15C20” (transmission coordinate system of the communication target). The information “OUT_R05C07” indicates that the secondary scan signal has been transmitted toward the scan address “R05C07” in the transmission coordinate system of the host device.

The signal generation unit 197 generates a primary communication establishment signal in response to an instruction from the signal analysis unit 196. The primary communication establishment signal is a spatial light signal for notifying the communication target of the light transmission source of the secondary scan signal that the secondary scan signal transmitted from the communication target has been received. The primary communication establishment signal includes the scan address (the transmission coordinate system of the host device) of the target of the primary scan signal transmitted from the host device. The primary communication establishment signal includes position coordinates of a scan address (transmission coordinate system of the communication target) of the target of the secondary scan signal transmitted by the communication target. For example, the signal generation unit 197 generates a primary communication establishment signal including information “HIT_R15C20, RCV_R08C10”. The information “HIT_R15C20” indicates that the host device has received the secondary scan signal, from the communication target, making a notification that the primary scan signal transmitted from the host device to the scan address “R15C20” (transmission coordinate system of the host device) is received. The information “RCV_R08C10” indicates that the communication target has received the secondary scan signal transmitted to the scan address “R08C10” (the transmission coordinate system of the communication target).

The signal generation unit 197 generates a secondary communication establishment signal in response to an instruction from the signal analysis unit 196. The secondary communication establishment signal is a signal for notifying the communication target of the light transmission source of the primary communication establishment signal that the primary communication establishment signal transmitted from the communication target has been received. The secondary communication establishment signal includes the scan address (the transmission coordinate system of the host device) of the target of the secondary scan signal transmitted from the host device. The secondary communication establishment signal includes position coordinates of the scan address (transmission coordinate system of the communication target) of the target of the primary communication establishment signal transmitted by the communication target. For example, the signal generation unit 197 generates a secondary communication establishment signal including information “HIT_R08C10, RCV_R15C20”. The information “HIT_R08C10” indicates that the host device has received a primary communication establishment signal, from a communication target, making a notification that a secondary scan signal transmitted from the host device to the scan address “R08C10” (transmission coordinate system of the host device) has been received. The information “RCV_R15C20” indicates that the communication target has received the primary communication establishment signal transmitted to the scan address “R15C20” (transmission coordinate system of the communication target).

The signal generation unit 197 generates a communication signal in response to an instruction from the signal analysis unit 196. The communication signal is a signal transmitted and received between the communication devices 1 in which communication is established when a communication path for transmitting and receiving a spatial light signal is determined. The communication signal includes information to be transmitted toward the communication target. The information added to the communication signal may be predetermined content or content related to information included in the communication signal from the communication target. For example, in a case where a communication signal having content related to information included in a communication signal from a communication target is generated, the information included in the communication signal transmitted from the communication target is displayed on a display device (not illustrated). For example, the operator who has confirmed the information displayed on the display device inputs a response to the displayed information to the communication control device 19 (signal generation unit 197) via an input device (not illustrated). For example, the signal generation unit 197 generates a communication signal including the input information.

### [Communication Establishment Procedure]

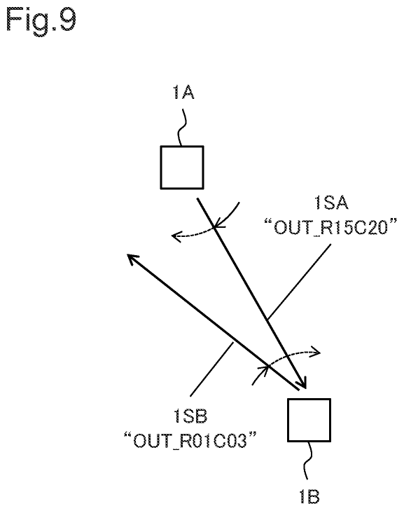

Next, a sequence in which communication is established between two communication devices 1 will be described with reference to the drawings. FIGS. 9 to 13 are conceptual diagrams for describing a sequence in which communication is established between the communication device 1A and the communication device 1B. FIGS. 9 to 13 illustrate transitions from when the communication device 1B receives the primary scan signal transmitted from the communication device 1A to when the communication device 1A receives the secondary communication establishment signal transmitted from the communication device 1B. In the stage of FIG. 9, it is assumed that the communication device 1A and the communication device 1B transmit the primary scan signal.

In the stage of FIG. 9, a primary scan signal 1SA transmitted from the communication device 1A is received by the communication device 1B. Until the stage of FIG. 9, the communication device 1A and the communication device 1B do not detect each other. In the stage of FIG. 9, the communication device 1B detects the communication device 1A.

The communication device 1A transmits the primary scan signal 1SA including information “OUT_R15C20” toward the scan address “R15C20” of the communication device 1A in the transmission coordinate system. “OUT” is a header indicating a scan address (transmission coordinate system of the host device) of the target of the spatial light signal to be transmitted. The information “OUT_R15C20” indicates that the primary scan signal 1SA is transmitted toward the scan address “R15C20” of the communication device 1A in the transmission coordinate system. The primary scan signal 1SA transmitted from the communication device 1A is received by the communication device 1B.

On the other hand, the communication device 1B transmits a primary scan signal 1SB including information “OUT_R01C03” toward the scan address “R01C03” of the communication device 1B in the transmission coordinate system. The information “OUT_R01C03” indicates that the primary scan signal 1SB is transmitted toward the scan address “R01C03” of the communication device 1B in the transmission coordinate system. The primary scan signal 1SB transmitted from the communication device 1B is not received by the communication device 1B.

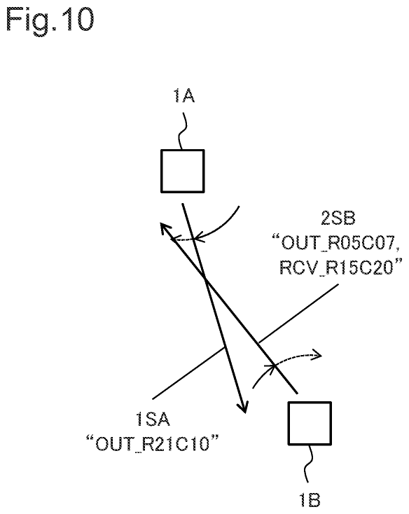

In the stage of FIG. 10, neither the primary scan signal 1SA transmitted from the communication device 1A nor the secondary scan signal 2SB transmitted from the communication device 1B is received. In the stage of FIG. 10, the communication device 1B detects the communication device 1A, but the communication device 1A does not detect the communication device 1B.

The communication device 1A continues to transmit the primary scan signal 1SA including information “OUT_R21C10”. The primary scan signal 1SA is transmitted toward a scan address “R21C10” of the communication device 1A in the transmission coordinate system.

On the other hand, the communication device 1B transmits a secondary scan signal 2SB including information “OUT_R05C07, RCV_R15C20”. The secondary scan signal 2SB is transmitted toward the scan address “R15C20” of the communication device 1B in the transmission coordinate system.

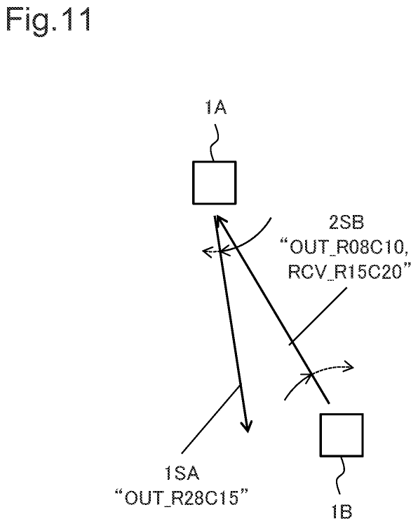

In a stage of FIG. 11, the communication device 1A transmits the primary scan signal 1SA including information “OUT_R28C15”. The primary scan signal 1SA is transmitted toward a scan address “R28C15” of the communication device 1A in the transmission coordinate system. The communication device 1A receives the secondary scan signal 2SB including information “OUT_R08C10, RCV_R15C20”. The communication device 1A detects the communication device 1B by receiving the secondary scan signal 2SB. The communication device 1A can identify that the communication device 1B is located in the direction of the scan address “RCV_R15C20” of the communication device 1A in the transmission coordinate system based on the information “RCV_R15C20” included in the secondary scan signal 2SB.

On the other hand, the communication device 1B transmits the secondary scan signal 2SB including information “OUT_R08C10, RCV_R15C20”. The secondary scan signal 2SB is transmitted toward a scan address “R08C10” of the communication device 1B in the transmission coordinate system.

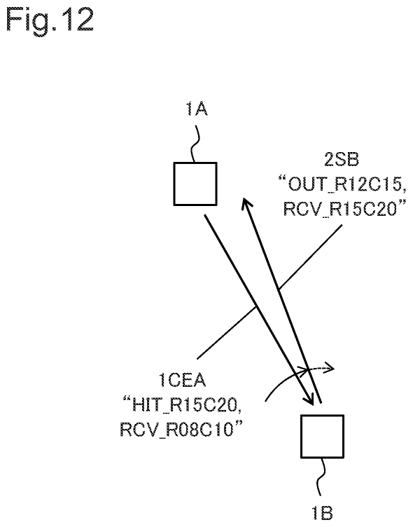

In the stage of FIG. 12, in response to the reception of the secondary scan signal 2SB transmitted from the communication device 1B, the communication device 1A transmits a primary communication establishment signal 1CEA including information making a notification that the secondary scan signal 2SB has been received. The communication device 1A transmits the primary communication establishment signal 1CEA toward a node of the position coordinates “RCV_R15C20” of the communication device 1A in the transmission coordinate system according to information “RCV_R15C20” included in the secondary scan signal 2SB from the communication device 1B. The communication device 1A transmits the primary communication establishment signal 1CEA including information “HIT_R15C20, RCV_R08C10”.

On the other hand, the communication device 1B transmits the secondary scan signal 2SB including information “OUT_R12C15, RCV_R15C20”. The communication device 1B receives the primary communication establishment signal 1CEA transmitted from the communication device 1A. The communication device 1B receives a primary communication establishment signal 1CEA including information “HIT_R08C10, RCV_R15C20”. At this stage, the communication device 1B can identify that the communication device 1A is located in the direction of the scan address “R08C10” of the communication device 1B in the transmission coordinate system.

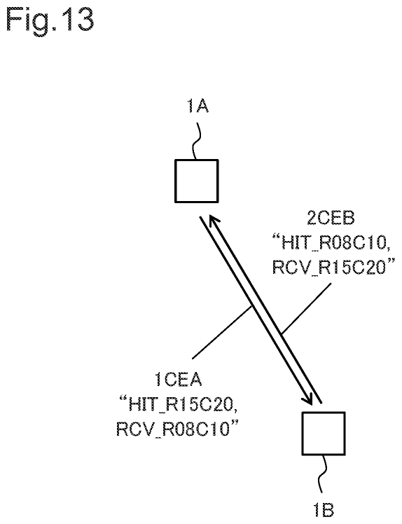

In the stage of FIG. 13, in response to the reception of the primary communication establishment signal 1CEA transmitted from the communication device 1A, the communication device 1B transmits a secondary communication establishment signal 2CEB including information making a notification that the primary communication establishment signal 1CEA has been received. The communication device 1B recognizes that the communication device 1A is located in the direction of the scan address “R08C10” of the communication device 1B in the transmission coordinate system based on the information “RCV_R08C10” included in the primary communication establishment signal 1CEA. The communication device 1B transmits the secondary communication establishment signal 2CEB toward the scan address “R08C10” of the communication device 1B in the transmission coordinate system. The communication device 1B transmits the secondary communication establishment signal 2CEB including information “HIT_R08C10, RCV_R15C20”. The information “HIT_R08C10” indicates that the primary communication establishment signal 1CEA related to the secondary scan signal 2SB transmitted to the scan address “R08C10” of the communication device 1B in the transmission coordinate system is received. The secondary communication establishment signal 2CEB including the information “HIT_R08C10, RCV_R15C20” is received by the communication device 1A located in the direction of the scan address “R08C10” of the communication device 1B in the transmission coordinate system.

On the other hand, the communication device 1A continues to transmit the primary communication establishment signal 1CEA including the information “HIT_R15C20, RCV_R08C10” toward “15C20” (the direction of the communication device 1B) of the communication device 1A in the transmission coordinate system. The communication device 1A receives the secondary communication establishment signal 2CEB transmitted from the communication device 1B. The secondary communication establishment signal 2CEB includes information “HIT_R08C10, RCV_R15C20”.

As illustrated in FIG. 13, the communication device 1B receives the primary communication establishment signal transmitted from the communication device 1A, and the communication device 1A receives the secondary communication establishment signal transmitted from the communication device 1B, whereby communication between the communication device 1A and the communication device 1B is established. That is, communication is established at a time point when both the communication device 1A and the communication device 1B transmit and receive the communication establishment signal. A communication scheme between the communication device 1A and the communication device 1B performed after the communication is established is not particularly limited. For example, the communication device 1A may start desired communication on the assumption that communication with the communication device 1B is established before receiving the secondary communication establishment signal transmitted from the communication device 1B. For example, the communication device 1A may start desired communication at a time point when a predetermined time has elapsed since the transmission of the primary communication establishment signal.

### [Optimization]

Next, an example of optimizing the light receiving state of the spatial light signal will be described with reference to the drawings. Hereinafter, a case where spatial light signals transmitted from a communication target toward a plurality of scan addresses is received and a case where a spatial light signal transmitted from a communication target toward a single scan address is received will be separately described.

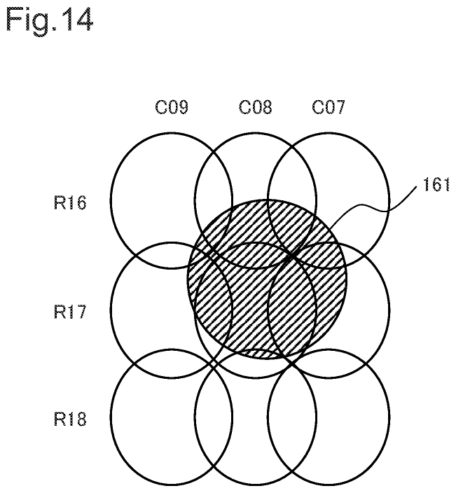

FIG. 14 illustrates an example in which a plurality of spatial light signals transmitted from a communication target toward a plurality of scan addresses is received within a predetermined period. The predetermined period is a period in which the spatial light signals are transmitted from the communication target toward the scan addresses adjacent to each other. In other words, FIG. 14 illustrates an example in which the spatial light signals transmitted from the communication target are received a plurality of times within the predetermined period. In the example of FIG. 14, the irradiation ranges irradiated with the spatial light signals transmitted toward the adjacent scan addresses among the spatial light signals transmitted toward the plurality of scan addresses overlap with each other. Specifically, in a case where the irradiation range irradiated with the spatial light signal is smaller than the diameter of the concentrator 161, the spatial light signals transmitted from the communication target are received toward the plurality of scan areas. In the example of FIG. 14, the spatial light signals transmitted from the communication target toward the scan addresses R16C07, R16C08, R16C09, R17C07, R17C08, and R17C09 of the communication target in the transmission coordinate system are received. The spatial light signal transmitted toward the scan address R18C08 of the communication target in the transmission coordinate system is also received, but is assumed to be equal to or less than the detection sensitivity.

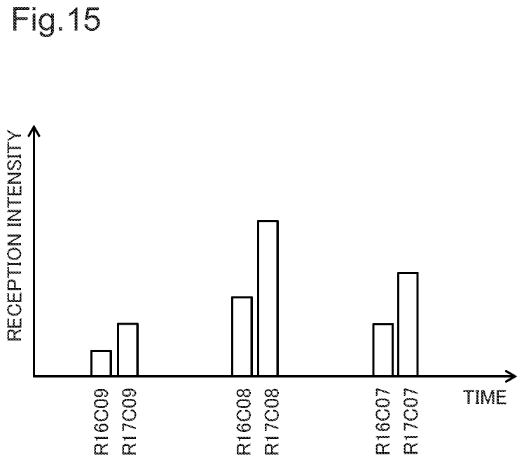

FIG. 15 is a graph illustrating an example of the intensity of the spatial light signal received in the example of FIG. 14. The horizontal axis of the graph of FIG. 15 indicates the time when the spatial light signal is received. In the example of FIG. 15, spatial light signals whose transmission position coordinates of the communication target in the transmission coordinate system are R16C09, R17C09, R16C08, R17C08, R16C07, and R17C07 are sequentially received.

In the case of the examples of FIGS. 14 to 15, there are several methods for setting the scan address of the communication target included in the response to the received spatial light signal. Two methods will be described. In the following method, an example will be described in which the signal acquisition unit 195 acquires the reception intensity of the spatial light signal, and the signal analysis unit 196 sets the spatial light signal scan address for the response according to the reception intensity of the acquired spatial light signal.

The first method is a method of responding based on the scan address of the communication target included in the spatial light signal having the maximum reception intensity among the plurality of spatial light signals. In FIG. 15, the reception intensity of the spatial light signal of the scan address “R17C08” of the communication target in the transmission coordinate system is the maximum. For example, the signal analysis unit 196 outputs an instruction to generate a signal including the transmission position coordinate “R17C08” having the maximum reception intensity to the signal generation unit 197. For example, the signal generation unit 197 generates a signal including the scan address “R17C08” of the communication target in the transmission coordinate system according to the instruction of the signal analysis unit 196. For example, in a case where the secondary scan signal is generated in response to reception of the primary scan signal, the signal generation unit 197 generates the secondary scan signal including information “RCV_R17C08”. The information “RCV_R17C08” indicates that the primary scan signal transmitted toward the scan address “R17C08” of the communication target in the transmission coordinate system is received.

The second method is a method of responding based on a geometric center (also referred to as a center of gravity) calculated using reception intensities of spatial light signals projected toward a plurality of scan addresses. For example, according to FIG. 15, it is assumed that the center of gravity of the reception intensities of the spatial light signals projected toward the plurality of scan addresses is the scan address “R16.7C7.8” of the communication target in the transmission coordinate system. In this case, when the spatial light signal is transmitted from the communication target toward the scan address “R16.7C7.8” of the communication target in the transmission coordinate system, the irradiation position irradiated with the spatial light signal from the communication target is optimized to the central position of the concentrator 161. For example, the signal analysis unit 196 outputs, to the signal generation unit 197, an instruction to generate a signal including the scan address “R16.7C7.8” corresponding to the center of gravity of the spatial light signals projected toward the plurality of scan addresses. For example, the signal generation unit 197 generates a signal including the scan address “R16.7C7.8” of the communication target in the transmission coordinate system according to the instruction by the signal analysis unit 196. For example, in a case where the secondary scan signal is generated in response to reception of the primary scan signal, the signal generation unit 197 may generate the secondary scan signal requesting transmission of the primary scan signal including the scan address “R16.7C7.8” of the communication target in the transmission coordinate system. For example, the signal generation unit 197 generates a secondary scan signal including information “RCV_R16.7C7.8”. When the primary communication establishment signal in response to the secondary scan signal is transmitted toward the scan address “RCV_R16.7C7.8” of the communication target in the transmission coordinate system, the reception intensity of the spatial light signal received by the host device is optimized.

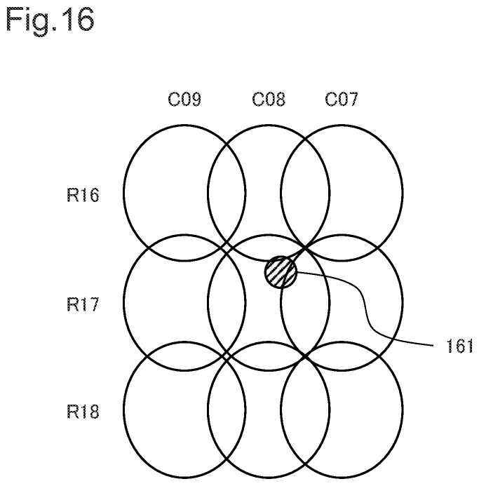

FIG. 16 illustrates an example in which a spatial light signal transmitted from a communication target toward a single scan address is received within a predetermined period. The predetermined period is a period in which the spatial light signals are transmitted from the communication target toward the scan addresses adjacent to each other. In other words, FIG. 16 illustrates an example in which the spatial light signal transmitted from the communication target is received a single number of times within the predetermined period. In the example of FIG. 16, the irradiation ranges irradiated with the spatial light signals transmitted toward the adjacent scan addresses among the spatial light signals transmitted toward the plurality of scan addresses overlap with each other. Specifically, the irradiation range irradiated with the spatial light signal transmitted from the distant communication target is larger than the diameter of the concentrator 161. Therefore, the diameter of the concentrator 161 falls inside the irradiation range irradiated with the spatial light signal. The intensity of the spatial light signal increases near the center of the irradiation range and decreases toward the peripheral edge of the irradiation range. When the concentrator 161 is located at a position close to the peripheral edge of the irradiation range, sufficient sensitivity may not be obtained. Therefore, it is desirable that the light transmission direction of the spatial light signal transmitted from the communication target is optimized in such a way that the concentrator 161 is positioned at the central portion of the irradiation range irradiated with the spatial light signal.

In the case of the example of FIG. 16, the spatial light signal transmitted to the scan address “R17C08” of the communication target in the transmission coordinate system is received by the communication device 1 via the concentrator 161. The communication device 1 transmits, toward the communication target, a spatial light signal including information indicating that only a spatial light signal transmitted from the communication target toward a single scan address has been received. For example, the communication device 1 adds a header such as “SGL” to a signal as information indicating that only a spatial light signal transmitted from a communication target toward a single scan address has been received. For example, the communication device 1 transmits a spatial light signal including information “SGL_R17C08”. The communication target that has received the spatial light signal including the information “SGL_R17C08” responds to the spatial light signal. For example, the communication target performs the detailed scan based on the scan address “SGL_R17C08” of the communication target in the transmission coordinate system.

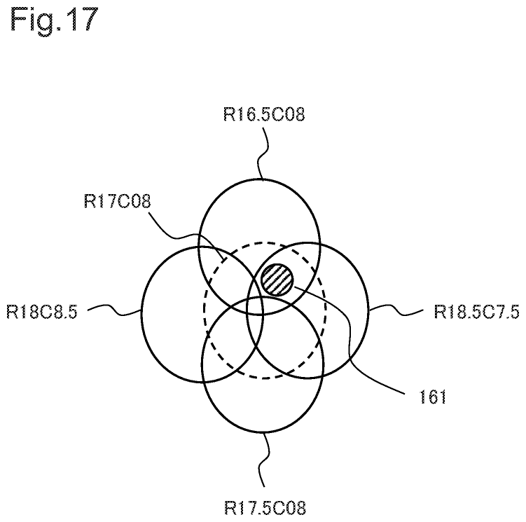

FIG. 17 is a conceptual diagram for describing detailed scanning performed by a communication target in response to a request from the communication device 1. In the detailed scan, the light transmission range of the spatial light signal is narrowed. In the example of FIG. 17, the light transmission range of the spatial light signal is narrowed around the scan address “SGL_R17C08” of the communication target in the transmission coordinate system. The example of FIG. 17 illustrates a state in which the spatial light signal is transmitted from the communication target toward the scan addresses “R16.5C8”, “R18C8.5”, “R18C07.5”, and “R17.5C08” of the communication target in the transmission coordinate system. The communication device 1 transmits the spatial light signals transmitted from the communication target toward the plurality of scan addresses. For example, in response to the reception of the spatial light signals transmitted from the communication target toward the plurality of scan addresses, the communication device 1 identifies the position of the communication target based on the maximum value of the reception intensity or the geometric center (center of gravity). For example, in a case where the center of gravity of the spatial light signals transmitted from the communication target toward the plurality of scan addresses is “R16.2C7.8”, the communication device 1 transmits the spatial light signal including information “R16.2C7.8”. The communication between the two communication devices 1 can be optimized by the communication target that has received the spatial light signal including the information “R16.2C7.8” transmitting the spatial light signal toward the scan address “R16.2C7.8” of the communication target in the transmission coordinate system.

[Establishment of Communication with a Plurality of Communication Targets]

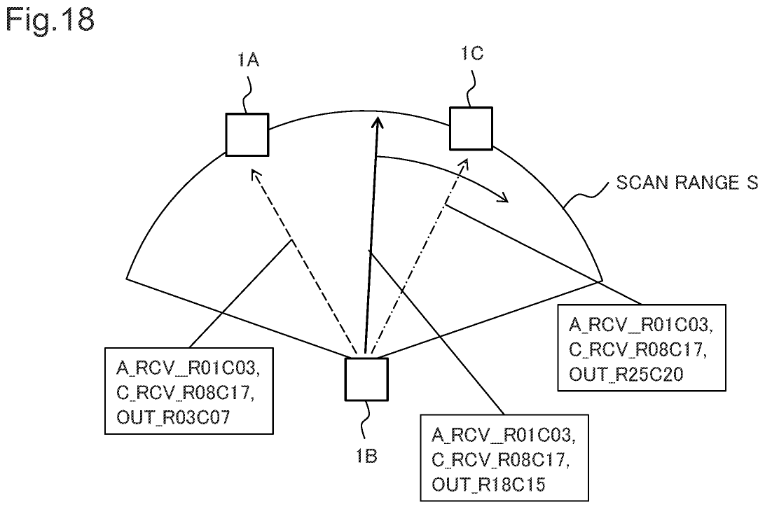

FIG. 18 is a conceptual diagram for describing an example of scanning a plurality of communication targets. In the example of FIG. 18, the communication device 1A, the communication device 1B, and a communication device 1C are disposed at positions where the communication device 1A, the communication device 1B, and the communication device 1C can transmit and receive spatial light signals to and from each other. When scanning a plurality of communication targets, an identifier for uniquely identifying each communication device 1 is used. For example, as an identifier for uniquely identifying the communication device 1, an IP address for each communication device 1 can be used (Internet protocol (IP)). However, in a case where the light receiving element 17 is used alone as in the present example embodiment, in a case where the distance between the communication device 1A or the communication device 1C and the communication device 1B is very short, the operation as illustrated in FIG. 18 is possible. In a case where there is a plurality of light receiving elements as in the second example embodiment described later, there is no restriction on the distance.

The communication device 1B transmits a spatial light signal for scanning toward a scan range of the communication device 1B. In the example of FIG. 18, a fan-shaped range centered (vital point) on the communication device 1B is set as a scan range S of the communication device 1B. The communication device 1B transmits a scanning spatial light signal from left to right. The spatial light signal transmitted from the communication device 1B includes information for each communication target (Communication device 1A, communication device 1C). An identifier A of the communication device 1A is assigned to the information for the communication device 1A. An identifier C of the communication device 1C is assigned to the information for the communication device 1C. The example of FIG. 18 is a situation after the communication device 1B receives the primary scan signal transmitted from the communication device 1A and the primary scan signal transmitted from the communication device 1C. The communication device 1B transmits a secondary scan signal according to the received primary scan signal.

In the example of FIG. 18, the communication device 1B transmits three types of spatial light signals. The first signal is a spatial light signal (broken line) including information “A_RCV_R01C03, C_RCV_R08C17, OUT_R03C07”. The first spatial light signal (broken line) is transmitted toward the scan address “R03C07” of the communication device 1B in the transmission coordinate system. The first spatial light signal (broken line) is received by the communication device 1A. The second signal is a spatial light signal (solid line) including information “A_RCV_R01C03, C_RCV_R08C17, OUT_R18C15”. The second spatial light signal (solid line) is transmitted toward the scan address “R18C15” of the communication device 1B in the transmission coordinate system. The second spatial light signal (solid line) is not received by any communication device 1. The third signal is a spatial light signal (one-dot chain line) including information “A_RCV_R01C03, C_RCV_R08C17, OUT_R25C20”. The third spatial light signal (one-dot chain line) is transmitted toward the scan address “R25C20” of the communication device 1B in the transmission coordinate system. The third spatial light signal (one-dot chain line) is received by the communication device 1C. The scan address of “OUT” included in the spatial light signal is changed according to the direction in which the communication device 1B transmits the spatial light signal.

The spatial light signal (broken line) received by the communication device 1A includes information “A_RCV_R01C03, C_RCV_R08C17, OUT_R03C07”. The communication device 1A receives the spatial light signal (broken line). The communication device 1A executes processing based on the information with which the identifier A of the communication device 1A is assigned. The communication device 1A identifies that the spatial light signal transmitted from the communication device 1A is received by the communication device 1B based on the information “A_RCV_R01C03”. The communication device 1A identifies that the received secondary scan signal has been transmitted toward the scan address “R03C07” of the communication device 1B in the light transmission coordinate system based on the information “OUT_R03C07”. For example, the communication device 1A transmits a primary communication establishment signal including information “RCV_R03C07” according to the received secondary scan signal. The communication device 1A transmits a primary communication establishment signal toward the scan address “R01C03” of the communication device 1A in the light transmission coordinate system. The communication device 1B is located in the direction of the scan address “R01C03” of the communication device 1A in the light transmission coordinate system. The primary communication establishment signal transmitted toward the scan address “R01C03” of the communication device 1A in the light transmission coordinate system is received by the communication device 1B.

The spatial light signal (one-dot chain line) received by the communication device 1C includes information “A_RCV_R01C03, C_RCV_R08C17, OUT_R25C20”. The communication device 1C receives the spatial light signal (one-dot chain line). The communication device 1C executes processing based on the information with which the identifier C of the communication device 1C is assigned. The communication device 1C recognizes that the spatial light signal transmitted from the communication device 1C is received by the communication device 1B based on the information “C_RCV_R08C17”. The communication device 1C recognizes that the secondary scan signal is transmitted toward the primary communication establishment signal “R25C20” of the communication device 1B in the light transmission coordinate system based on the information “OUT_R25C20”. For example, the communication device 1C transmits a primary communication establishment signal including information “RCV_R08C17” according to the received secondary scan signal. The communication device 1C transmits the primary communication establishment signal toward the scan address “R25C20” of the communication device 1C in the light transmission coordinate system. The communication device 1B is located in the direction of the scan address “R25C20” of the communication device 1C in the light transmission coordinate system.

Communication between the communication device 1A and the communication device 1B is established when the secondary communication establishment signal transmitted from the communication device 1B according to the primary communication establishment signal described above is received by the communication device 1A. Communication between the communication device 1B and the communication device 1C is established when the secondary communication establishment signal transmitted from the communication device 1B according to the primary communication establishment signal described above is received by the communication device 1C. With such a procedure, communication with a plurality of communication targets can be established.

As described above, the communication device of the present example embodiment includes a light transmitting device, a light receiving device, and a communication control device. The light transmitting device transmits a spatial light signal (first spatial light signal) under the control of the communication control device. The light receiving device receives a spatial light signal (second spatial light signal) transmitted from the communication target. The light receiving device outputs a reception signal included in the received second spatial light signal to the communication control device. The communication control device includes a condition storage unit, a light transmission condition generation unit, a light transmission control unit, a signal acquisition unit, a signal analysis unit, and a signal generation unit. The light transmission condition generation unit generates a light transmission condition for transmitting the spatial light signal based on the condition stored in the condition storage unit. The light transmission condition generation unit generates a light transmission condition for transmitting the first spatial light signal including the transmission signal toward the address (first address) in the transmission coordinate system (first transmission coordinate system) set in the host device according to the transmission signal generated by the signal generation unit. The light transmission control unit controls the light transmitting device in such a way as to transmit the first spatial light signal based on the light transmission condition generated by the light transmission condition generation unit. The signal acquisition unit acquires a reception signal included in the second spatial light signal from the light receiving device that has received the second spatial light signal transmitted from the communication target. The signal analysis unit analyzes the reception signal acquired by the signal acquisition unit, and extracts an address (second address) of the communication target in the transmission coordinate system (second transmission coordinate system) included in the reception signal. The signal generation unit generates a transmission signal including an address (first address) of a light transmission destination of the first spatial light signal transmitted from the host device. The signal generation unit generates the transmission signal including the first address and the second address according to an analysis result of the reception signal included in the second spatial light signal transmitted from the communication target. The signal generation unit outputs the generated transmission signal to the light transmission condition generation unit.

The communication device according to the present example embodiment exchanges the addresses of the light transmission destinations of the spatial light signals of the communication device and the communication target in the transmission coordinate system between the communication device and the communication target, thereby accurately grasping the positions of the communication device and the communication target. In the communication device according to the present example embodiment, it is not necessary for the communication device and the communication target to operate cooperatively, and it is not necessary to use an image or the like. Therefore, according to the communication device of the present example embodiment, communication with the communication target can be established in an any situation.

In an aspect of the present example embodiment, the signal generation unit generates a transmission signal in which the position of the first address has been sequentially changed within the range of the scan area in which the first transmission coordinate system set in the host device is set in the scan mode in which the communication target is searched for. The light transmission condition generation unit generates a light transmission condition for transmitting the first spatial light signal including the transmission signal toward the first address whose position is sequentially changed within the range of the scan area according to the transmission signal. The light transmission control unit controls the light transmitting device in such a way as to sequentially change the position of the first address within the range of the scan area and change the light transmission direction of the first spatial light signal for searching for the communication target. According to the present aspect, the communication target can be scanned by sequentially changing the position of the first address of the light transmission destination of the first spatial light signal within the range of the scan area in which the first transmission coordinate system is set.

In an aspect of the present example embodiment, the signal generation unit generates the first transmission signal including the first address in the first transmission coordinate system. The light transmission condition generation unit generates a first light transmission condition for transmitting a primary scan signal that is a first spatial light signal including the first transmission signal toward the first address according to the first transmission signal. The light transmission control unit controls the light transmitting device in such a way as to transmit the primary scan signal toward the first address based on the first light transmission condition. According to the present aspect, by transmitting the primary scan signal including the first address of the light transmission destination of the first spatial light signal, it is possible to notify the communication target of the light transmission destination of the first spatial light signal transmitted from the host device.

In an aspect of the present example embodiment, the signal generation unit generates the second transmission signal in response to reception of the primary scan signal transmitted from the communication target. The second transmission signal includes a second address in the second transmission coordinate system and a first address in the first transmission coordinate system, the second address being included in the primary scan signal transmitted from the communication target. The light transmission condition generation unit generates a second light transmission condition for transmitting the secondary scan signal that is the first spatial light signal including the second transmission signal toward the first address according to the second transmission signal. The light transmission control unit controls the light transmitting device in such a way as to transmit the secondary scan signal toward the first address based on the second light transmission condition. In the present aspect, in response to reception of the primary scan signal transmitted from the communication target, the secondary scan signal including the second address indicating the light transmission destination of the primary scan signal is transmitted back toward the communication target. Therefore, according to the present aspect, it is possible to notify the communication target located in the direction of the first address by the secondary scan signal that the primary scan signal transmitted from the communication target toward the second address is received.

In an aspect of the present example embodiment, the signal generation unit generates the third transmission signal in response to reception of the secondary scan signal transmitted from the communication target. The third transmission signal includes a second address in the second transmission coordinate system and a first address in the first transmission coordinate system, the second address being included in the secondary scan signal transmitted from the communication target. According to the third transmission signal, the light transmission condition generation unit generates a third light transmission condition for transmitting the primary communication establishment signal that is the first spatial light signal including the third transmission signal toward the first address. The light transmission control unit controls the light transmitting device in such a way as to transmit the primary communication establishment signal toward the first address based on the third light transmission condition. In the present aspect, in response to reception of the secondary scan signal transmitted from the communication target, the primary communication establishment signal including the second address indicating the light transmission destination of the secondary scan signal is transmitted back toward the communication target. Therefore, according to the present aspect, it is possible to notify the communication target located in the direction of the first address by the primary communication establishment signal that the secondary scan signal transmitted from the communication target toward the second address is received.

In an aspect of the present example embodiment, the signal generation unit generates the fourth transmission signal in response to reception of the primary communication establishment signal transmitted from the communication target. The third transmission signal includes a second address in the second transmission coordinate system and a first address in the first transmission coordinate system, the second address being included in the primary communication establishment signal transmitted from the communication target. The light transmission condition generation unit generates a fourth light transmission condition for transmitting the secondary communication establishment signal that is the first spatial light signal including the fourth transmission signal toward the first address according to the fourth transmission signal. The light transmission control unit controls the light transmitting device in such a way as to transmit the secondary communication establishment signal toward the first address based on the fourth light transmission condition. In the present aspect, in response to reception of the primary communication establishment signal transmitted from the communication target, the secondary communication establishment signal including the second address indicating the light transmission destination of the primary communication establishment signal is transmitted back toward the communication target. Therefore, according to the present aspect, it is possible to notify the communication target located in the direction of the first address by the secondary communication establishment signal that the primary communication establishment signal transmitted from the communication target toward the second address is received. As a result, communication between the communication target and the host device is established.

In an aspect of the present example embodiment, the signal analysis unit calculates the center of gravity of the second addresses in the second transmission coordinate system included in the second spatial light signals received a plurality of times according to the plurality of times of reception of the second spatial light signals within the predetermined period. The signal generation unit generates the transmission signal including the first address in the first transmission coordinate system, the first address being included in the second spatial light signal and the center of gravity of the second addresses. The light transmission condition generation unit generates a light transmission condition for transmitting the first spatial light signal including the transmission signal toward the first address included in the transmission signal according to the transmission signal. The light transmission control unit controls the light transmitting device in such a way as to transmit the first spatial light signal toward the first address based on the light transmission condition. In the present aspect, according to a plurality of times of reception of the second spatial light signals transmitted from the communication target, the first spatial light signal including the address corresponding to the center of gravity of the second addresses of the second spatial light signals is transmitted back to the communication target. Therefore, according to the present aspect, the communication target changes the light transmission destination of the second spatial light signal toward the center of gravity of the second addresses included in the returned first spatial light signal, whereby the light reception situation of the second spatial light signal in the host device can be optimized.

In an aspect of the present example embodiment, the signal generation unit generates the transmission signal including the second address in the second transmission coordinate system and the center of gravity of the first address, the second address being included in the second spatial light signal, according to reception of the second spatial light signal including the center of gravity of the first address. The light transmission condition generation unit generates a light transmission condition for transmitting the first spatial light signal including the transmission signal toward the center of gravity of the first address in the first transmission coordinate system according to the transmission signal. The light transmission control unit controls the light transmitting device in such a way as to transmit the first spatial light signal toward the center of gravity of the first address based on the light transmission condition. In the present aspect, the light transmission destination of the first spatial light signal is directed to the center of gravity of the received first address according to reception of the center of gravity of the first address included in the second spatial light signal transmitted from the communication target. Therefore, according to the present aspect, the host device changes the light transmission destination of the first spatial light signal toward the center of gravity of the first address included in the transmitted and received second spatial light signal, whereby the light reception situation of the first spatial light signal in the communication target can be optimized.

In an aspect of the present example embodiment, the signal generation unit generates the transmission signal according to a single reception of the second spatial light signal within the predetermined period. The transmission signal includes a request for narrowing the light transmission direction of the second spatial light signal around the second address included in the received second spatial light signal, a first address in the first transmission coordinate system included in the second spatial light signal, and a second address of the received second spatial light signal. The light transmission condition generation unit generates a light transmission condition for transmitting the first spatial light signal including the transmission signal toward the first address included in the transmission signal according to the transmission signal. The light transmission control unit controls the light transmitting device in such a way as to transmit the first spatial light signal toward the first address based on the light transmission condition. In the present aspect, in response to a single reception of the second spatial light signal transmitted from the communication target, the first spatial light signal including a request to narrow down the light transmission direction of the second spatial light signal around the second address included in the received second spatial light signal is transmitted back to the communication target. For example, the communication target narrows the light transmission destination of the second spatial light signal toward the second address included in the first spatial light signal as a response to the first spatial light signal. As a result, when the second spatial light signals can be received a plurality of times within the predetermined period, the light receiving state of the second spatial light signals in the host device can be optimized by transmitting back the first spatial light signal including the address corresponding to the center of gravity of the second addresses of the second spatial light signals to the communication target.

### Second Example Embodiment

Next, a communication device according to the second example embodiment will be described with reference to the drawings. The communication device of the present example embodiment is different from that of the first example embodiment in that the light receiving device includes a plurality of light receiving elements.

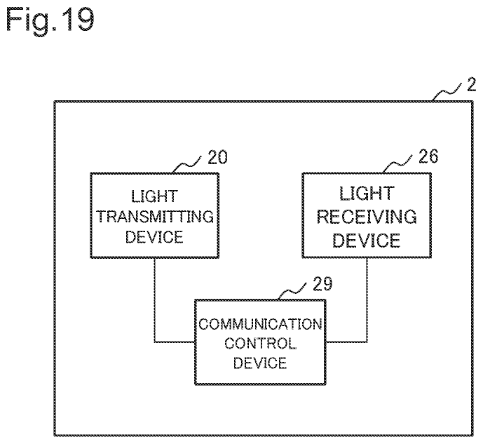

FIG. 19 is a block diagram illustrating an example of a configuration of a communication device 2 of the present example embodiment. The communication device 2 of the present example embodiment includes a light transmitting device 20, a light receiving device 26, and a communication control device 29. The light transmitting device 20 and the communication control device 29 are similar to those of the first example embodiment. Hereinafter, the description of the light transmitting device 20 and the communication control device 29 will be omitted, and the configuration of the light receiving device 26 will be described in detail.

### [Light Receiving Device]

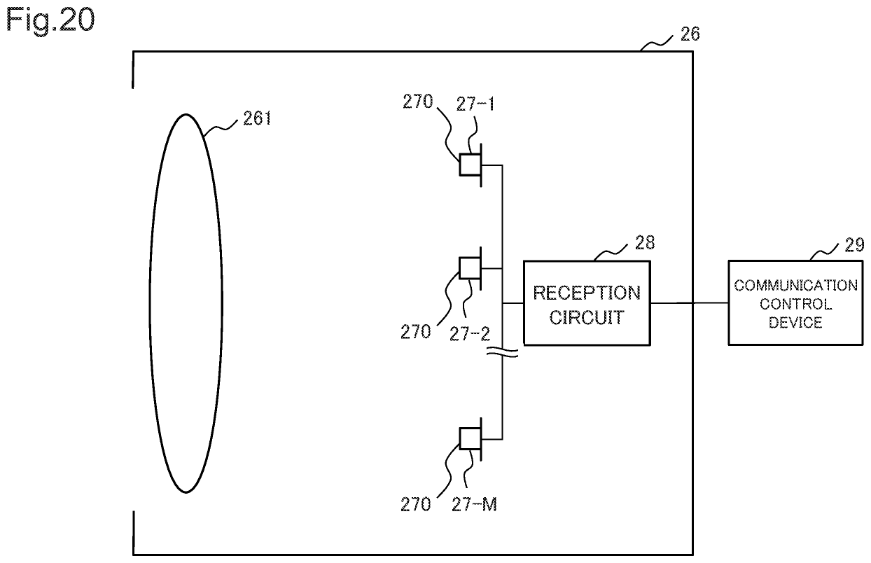

Next, a configuration of the light receiving device 26 will be described with reference to the drawings. FIG. 20 is a conceptual diagram for describing a configuration of the light receiving device 26. The light receiving device 26 includes a concentrator 261, a plurality of light receiving elements 27-1 to M, and a reception circuit 28 (M is a natural number equal to or more than 2.) Each of the plurality of light receiving elements 27-1 to M includes a light receiving unit 270. FIG. 20 is a plan view of the internal configuration of the light receiving device 26 when viewed from above. The position of the reception circuit 28 is not particularly limited. The reception circuit 28 may be disposed inside the light receiving device 26 or may be disposed outside the light receiving device 26. The communication control device 29 may include the function of the reception circuit 28.

The concentrator 261 is an optical element that collects a spatial light signal arriving from the outside. The spatial light signal is incident on the incident face of the concentrator 261. The light signal collected by the concentrator 261 is collected toward a region where the plurality of light receiving elements 27-1 to M is disposed. For example, the concentrator 261 is a lens that collects an incident spatial light signal. For example, the concentrator 261 is a light beam control element that guides the incident spatial light signal toward the light receiving units of the plurality of light receiving elements 27-1 to M. For example, the concentrator 261 may be configured by combining a lens and a light beam control measure. The configuration of the concentrator 261 is not particularly limited as long as the spatial light signal can be condensed toward the region where the plurality of light receiving elements 27-1 to M is disposed. For example, a mechanism for guiding the light signal collected by the concentrator 261 toward the light receiving unit 270 of each of the plurality of light receiving elements 27-1 to M may be added.

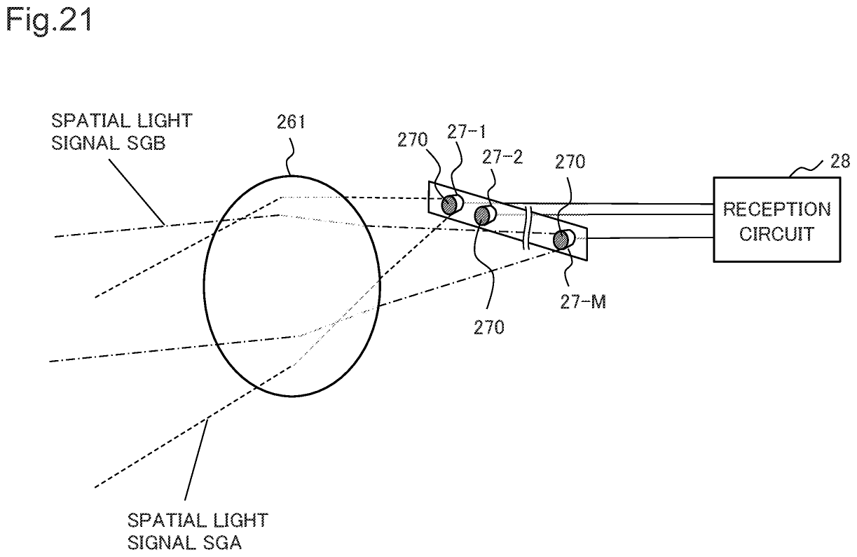

FIG. 21 is a conceptual diagram for describing an example of a trace of light received by the light receiving device 26. FIG. 21 is a perspective view of the internal configuration of the light receiving device 26 when viewed obliquely from the front. FIG. 21 illustrates an example in which the plurality of light receiving elements 27-1 to M is disposed in a row. The plurality of light receiving elements 27-1 to M can be disposed in an any array in accordance with the incoming direction of the spatial light signal. In the example of FIG. 21, a spatial light signal SGA and a spatial light signal SGB arriving from different directions are incident on the concentrator 261. The light signals derived from the spatial light signal SGA and the spatial light signal SGB are collected by the concentrator 261 and are collected toward the region where the plurality of light receiving elements 27-1 to M is disposed. As a result, the light signals derived from the spatial light signal SGA and the spatial light signal SGB are received by different light receiving elements 27.

Each of the plurality of light receiving elements 27-1 to M is disposed behind the concentrator 261. Each of the plurality of light receiving elements 27-1 to M includes the light receiving unit 270 that receives the light signal condensed by the concentrator 261. Each of the plurality of light receiving elements 27-1 to M is disposed in such a way that the emission surface of the concentrator 261 and the light receiving unit 270 face each other. The light signal collected by the concentrator 261 is received by the light receiving unit 270 of each of the plurality of light receiving elements 27-1 to M. Each of the plurality of light receiving elements 27-1 to M converts the received light signal into an electric signal (hereinafter, also referred to as a signal). Each of the plurality of light receiving elements 27-1 to M outputs the converted signal to the reception circuit 28. For example, each of the plurality of light receiving elements 27-1 to M is individually connected to the reception circuit 28. For example, a group of some of the plurality of light receiving elements 27-1 to M may be connected to the reception circuit 28.

The light receiving element 27 receives light in a wavelength region of the spatial light signal to be received. For example, the light receiving element 27 has sensitivity to light in the visible region. For example, the light receiving element 27 has sensitivity to light in an infrared region. The light receiving element 27 is sensitive to light having a wavelength in a 1.5 μm (micrometer) band, for example. The wavelength band of light to which the light receiving element 27 has sensitivity is not limited to the 1.5 μm band. The wavelength band of the light received by the light receiving element 27 can be set to any band in accordance with the wavelength of the spatial light signal to be received. The wavelength band of the light received by the light receiving element 27 may be set to, for example, a 0.8 μm band, a 1.55 μm band, or a 2.2 μm band. The wavelength band of the light received by the light receiving element 27 may be, for example, a band of 0.8 to 1 μm. A shorter wavelength band is advantageous for optical spatial communication during rainfall because absorption by moisture in the atmosphere is small. When the light receiving element 27 is saturated with intense sunlight, the light receiving element cannot read the light signal derived from the spatial light signal. Therefore, a color filter that selectively passes the light of the wavelength band of the spatial light signal may be installed before the light receiving element 27.

For example, the light receiving element 27 can be achieved by an element such as a photodiode or a phototransistor. For example, the light receiving element 27 is achieved by an avalanche photodiode. The light receiving element 27 achieved by the avalanche photodiode can support high speed communication. The light receiving element 27 may be achieved by an element other than a photodiode, a phototransistor, or an avalanche photodiode as long as a light signal can be converted into an electric signal. In order to improve the communication speed, the light receiving unit of the light receiving element 27 is preferably as small as possible. For example, the light receiving unit of the light receiving element 27 has a square light receiving surface having a side of about 5 mm (mm). For example, the light receiving unit of the light receiving element 27 has a circular light receiving surface having a diameter of about 0.1 to 0.3 mm. The size and shape of the light receiving unit of the light receiving element 27 may be selected according to the wavelength band, the communication speed, and the like of the spatial light signal.

For example, a light receiving filter (not illustrated) may be disposed before the light receiving element 27. The light receiving filter is disposed in association with the light receiving unit 270 of the light receiving element 27. For example, the light receiving filter is disposed to overlap the light receiving unit 270 of the light receiving element 27. The optical filter converts an optical characteristic of the light signal. For example, the light receiving filter is a color filter that selectively transmits light in a wavelength band of a light signal to be received. For example, the light receiving filter is a polarization filter that allows a change in a specific polarization state to pass therethrough. For example, when the spatial light signal of the light receiving target is linearly polarized light, the light receiving filter includes a ½ wavelength plate. For example, when the spatial light signal of the light receiving target is circularly polarized light, the light receiving filter includes a ¼ wavelength plate. The light receiving element 27 receives the light signal having the optical characteristics converted according to the optical characteristics of the light receiving filter.

The reception circuit 28 acquires a signal output from each of the plurality of light receiving elements 27-1 to M. The reception circuit 28 amplifies a signal from each of the plurality of light receiving elements 27-1 to M. The reception circuit 28 decodes the amplified signal and analyzes a signal from the communication target. For example, the reception circuit 28 collectively analyzes the signals of the plurality of light receiving elements 27-1 to M. In a case where the signals of the plurality of light receiving elements 27-1 to M are collectively analyzed, it is possible to achieve the single-channel light receiving device 26 that communicates with a single communication target. For example, the reception circuit 28 individually analyzes a signal for each of the plurality of light receiving elements 27-1 to M. In a case where signals are individually analyzed for each of the plurality of light receiving elements 27-1 to M, it is possible to achieve the multi-channel light receiving device 26 that simultaneously communicates with a plurality of communication targets. The signal decoded by the reception circuit 28 is used for any purpose. The use of the signal decoded by the reception circuit 28 is not particularly limited.

### [Reception Circuit]

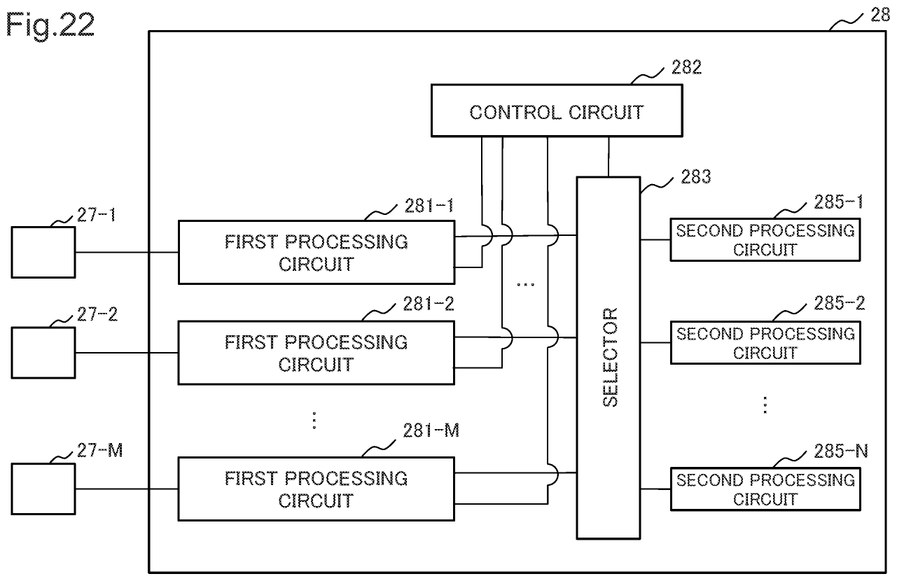

Next, an example of a detailed configuration of the reception circuit 28 included in the light receiving device 26 will be described with reference to the drawings. FIG. 22 is a block diagram illustrating an example of a configuration of the reception circuit 28. FIG. 22 illustrates an example of the configuration of the reception circuit 28, and does not limit the configuration of the reception circuit 28.

The reception circuit 28 includes a plurality of first processing circuits 281-1 to M, a control circuit 282, a selector 283, and a plurality of second processing circuits 285-1 to N (M and N are natural numbers). The first processing circuit 281 is associated with any one of the plurality of light receiving elements 27-1 to M. The first processing circuit 281 may be configured for each group of several light receiving elements 27 included in the plurality of light receiving elements 27-1 to M.

For example, the first processing circuit 281 includes a high-pass filter (not illustrated). The high-pass filter acquires a signal from the light receiving element 27. The high-pass filter selectively passes a signal of a high frequency component related to the wavelength band of the spatial light signal among the acquired signals. The high-pass filter cuts off a signal derived from ambient light such as sunlight. For example, instead of the high-pass filter, a band-pass filter that selectively transmits a signal in a wavelength band of a spatial light signal may be configured. When the light receiving element 27 is saturated with intense sunlight, a light signal cannot be read. Therefore, a color filter that selectively transmits the light in the wavelength band of the spatial light signal may be installed before the light receiving unit 270 of the light receiving element 27.

For example, the first processing circuit 281 includes an amplifier (not illustrated). The amplifier acquires the signal output from the high-pass filter. The amplifier amplifies the acquired signal. The amplification factor of the signal by the amplifier is not particularly limited.

For example, the first processing circuit 281 includes an output monitor (not illustrated). The output monitor monitors an output value of the amplifier. The output monitor outputs a signal exceeding a predetermined output value among the signals amplified by the amplifier to the selector 283. Among the signals input to the selector 283, the signal to be received is allocated to any one of the plurality of second processing circuits 285-1 to N under the control of the control circuit 282. The signal to be received is a spatial light signal from a communication device (not illustrated) to be communicated. A signal from the light receiving element 27 that is not used for receiving the spatial light signal is not output to the second processing circuit 285.

For example, the first processing circuit 281 may include an integrator (not illustrated) as an output monitor (not illustrated). The integrator acquires the signal output from the high-pass filter. The integrator integrates the acquired signal. The integrator outputs the integrated signal to the control circuit 282. The integrator is disposed to measure the intensity of the spatial light signal received by the light receiving element 27. The spatial light signal received in a state where the beam diameter is not narrowed has weaker intensity than that in a state where the beam diameter is narrowed. Therefore, it is difficult to measure the voltage of the signal amplified only by the amplifier with respect to the spatial light signal received in a state where the beam diameter is not narrowed. By using an integrator, for example, by integrating a signal in a period of several milliseconds to several tens of milliseconds, the voltage of the signal can be increased to a level at which the voltage can be measured.

The control circuit 282 acquires a signal output from each of the plurality of first processing circuits 281-1 to M. In other words, the control circuit 282 acquires a signal derived from a light signal received by each of the plurality of light receiving elements 27-1 to M. For example, the control circuit 282 compares the readings of the signals from the plurality of light receiving elements 27 adjacent to each other. The control circuit 282 selects the light receiving element 27 having the maximum signal intensity according to the comparison result. The control circuit 282 controls the selector 283 in such a way as to allocate the signal derived from the selected light receiving element 27 to any one of the plurality of second processing circuits 285-1 to N.

In a case where the position of the communication target is identified in advance, the processing of estimating the incoming direction of the spatial light signal is not performed, and the signals output from the light receiving elements 27-1 to M may be output to any of the preset second processing circuits 285. On the other hand, when the position of the communication target is not identified in advance, the second processing circuit 285 as an output destination of the signals output from the light receiving elements 27-1 to M may be selected. For example, when the control circuit 282 selects the light receiving element 27, the incoming direction of the spatial light signal can be estimated. Selecting the light receiving element 27 by the control circuit 282 corresponds to identifying the communication device of the light transmission source of the spatial light signal. Allocating the signal from the light receiving element 27 selected by the control circuit 282 to any one of the plurality of second processing circuits corresponds to associating the identified communication target with the light receiving element 27 that receives the spatial light signal from the communication target. That is, the control circuit 282 can identify the communication target (communication device) of the light transmission source of the light signal (spatial light signal) based on the light signal received by the plurality of light receiving elements 27-1 to M.

The signal amplified by the amplifier included in each of the plurality of first processing circuits 281-1 to M is input to the selector 283. The selector 283 outputs a signal to be received among the input signals to any one of the plurality of second processing circuits 285-1 to N according to the control of the control circuit 282. A signal that is not to be received is not output from the selector 283.

A signal from any one of the plurality of light receiving elements 27-1 to N allocated by the control circuit 282 is input to any of the plurality of second processing circuits 285-1 to N. Each of the plurality of second processing circuits 285-1 to N decodes the input signal. Each of the plurality of second processing circuits 285-1 to N may be configured to perform some signal process on the decoded signal, or may be configured to output the signal to an external signal processing device or the like (not illustrated).

When the selector 283 selects a signal derived from the light receiving element 27 selected by the control circuit 282, one second processing circuit 285 is allocated to one communication target. That is, the control circuit 282 allocates the signals derived from the spatial light signals from the plurality of communication targets received by the plurality of light receiving elements 27-1 to M to any of the plurality of second processing circuits 285-1 to N. As a result, the light receiving device 26 can simultaneously read signals derived from spatial light signals from a plurality of communication targets on individual channels. For example, in order to simultaneously communicate with a plurality of communication targets, spatial light signals from the plurality of communication targets may be read in time division on a single channel. In the method of the present example embodiment, since spatial light signals from a plurality of communication targets are simultaneously read in a plurality of channels, a transmission speed is faster than that in a case where a single channel is used.

For example, the incoming direction of the spatial light signal may be identified by the primary scan with coarse accuracy, and the secondary scan with fine accuracy may be performed with respect to the identified direction to identify the accurate position of the communication target. When communication with the communication target is possible, an accurate position of the communication target can be determined by exchanging signals with the communication target. When the position of the communication target is identified in advance, the process of identifying the position of the communication target can be omitted.

[Establishment of Communication with a Plurality of Communication Targets]

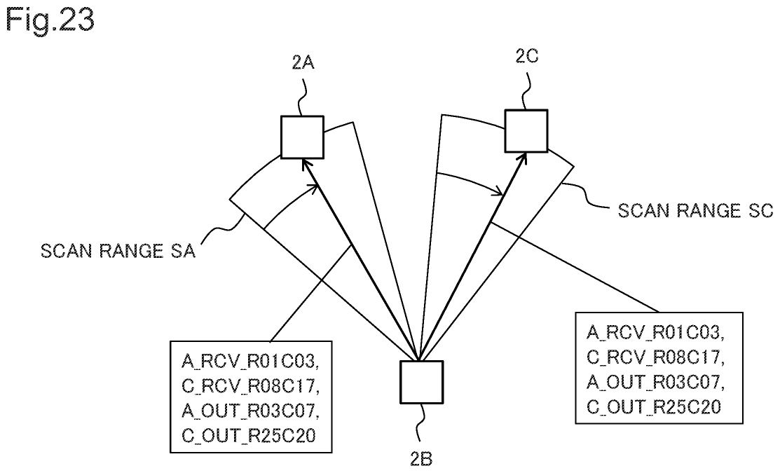

FIG. 23 is a conceptual diagram for describing an example of scanning a plurality of communication targets. In the example of FIG. 23, a communication device 2A, a communication device 2B, and a communication device 2C are disposed at positions where the communication device 2A, the communication device 2B, and the communication device 2C can transmit and receive spatial light signals to and from each other. In the case of scanning a plurality of communication targets, an identifier for uniquely identifying each communication device 2 is used. For example, as an identifier for uniquely identifying the communication device 2, an IP address for each communication device 2 can be used (Internet protocol (IP)).

The communication device 2B transmits a scanning spatial light signal toward the scan range of the communication device 2B. In the case of the present example embodiment, since the spatial light signal is received using the plurality of light receiving elements 27-1 to M, a plurality of scan ranges can be set. In the example of FIG. 23, two fan-shaped ranges centered (vital point) on the communication device 2B are set as the scan range (scan range SA, scan range SC) of the communication device 2B.

The communication device 2B transmits a spatial light signal for scanning each of the scan range SA and the scan range SC from the left side to the right side. The spatial light signal transmitted from the communication device 2B includes information for a communication target (communication device 2A, communication device 2B). An identifier A of the communication device 2A is assigned to the information for the communication device 2A. An identifier C of the communication device 2C is assigned to the information for the communication device 2C. The example of FIG. 23 is a situation after the communication device 2B receives the primary scan signal transmitted from the communication device 2A and the primary scan signal transmitted from the communication device 2C. The communication device 2B transmits a secondary scan signal to each of the communication device 2A and the communication device 2C according to the received primary scan signal.

In the example of FIG. 23, the communication device 2B transmits the same spatial light signal in two directions. The communication device 2B transmits the spatial light signal including information “A_RCV_R01C03, C_RCV_R08C17, A_OUT_R03C07, C_R25C20”. The spatial light signal is transmitted in two directions in which the scan addresses of the communication device 2B in the transmission coordinate system are “R03C07” and “R25C20”. The scan address of the communication device 2B in the transmission coordinate system, the scan address being included in the spatial light signal, is changed according to the direction in which the communication device 2B transmits the spatial light signal.

The communication device 2A receives the spatial light signal transmitted to the scan range SA. The communication device 2A executes processing based on the information with which the identifier A of the communication device 2A is assigned. The communication device 2A identifies that the spatial light signal transmitted from the communication device 2A is received by the communication device 2B based on the information “A_RCV_R01C03”. The communication device 2A identifies that the secondary scan signal for the communication device 2A is transmitted toward the scan address “R03C07” of the communication device 2B in the light transmission coordinate system based on the information “A_OUT_R03C07”. For example, the communication device 2A transmits a primary communication establishment signal including information “RCV_R03C07” according to the received secondary scan signal. The communication device 2A transmits the primary communication establishment signal toward the scan address “R01C03” of the communication device 2A in the light transmission coordinate system. The communication device 2B is located in the direction of the scan address “R01C03” of the communication device 2A in the light transmission coordinate system. The primary communication establishment signal transmitted toward the scan address “R01C03” of the communication device 2A in the light transmission coordinate system is received by the communication device 2B.

The communication device 2C receives the spatial light signal transmitted to the scan range SC. The communication device 2C executes processing based on the information with which the identifier C of the communication device 2C is assigned. The communication device 2C identifies that the spatial light signal transmitted from the communication device 2C is received by the communication device 2B based on the information “C_RCV_R08C17”. The communication device 2C identifies that the secondary scan signal toward the communication device 2C is transmitted toward the scan address “R25C20” of the communication device 2B in the light transmission coordinate system based on the information “C_OUT_R25C20”. For example, the communication device 2C transmits a primary communication establishment signal including information “RCV_R08C17” according to the received secondary scan signal. The communication device 2C transmits the primary communication establishment signal toward the scan address “R25C20” of the communication device 1C in the light transmission coordinate system. The communication device 2B is located in the direction of the scan address “R25C20” of the communication device 2C in the light transmission coordinate system. The primary communication establishment signal transmitted toward the scan address “R25C20” of the communication device 2B in the light transmission coordinate system is received by the communication device 2B.

Communication between the communication device 2A and the communication device 2B is established when the secondary communication establishment signal transmitted from the communication device 2B according to the primary communication establishment signal is received by the communication device 2A. Communication between the communication device 2B and the communication device 2C is established when the secondary communication establishment signal transmitted from the communication device 2B according to the primary communication establishment signal described above is received by the communication device 2C. With such a procedure, communication with a plurality of communication targets can be established. In the method of the present example embodiment, since the light receiving device 26 includes the plurality of light receiving elements 27-1 to M, it is possible to set a plurality of scan ranges in which the scan angle is narrowed. Therefore, according to the method of the present example embodiment, the time required for establishing communication with a plurality of communication targets can be shortened as compared with the case where the number of light receiving elements 27 is one.

As described above, the communication device of the present example embodiment includes a light transmitting device, a light receiving device, and a communication control device. The light transmitting device transmits the first spatial light signal under the control of the communication control device. The light receiving device includes a plurality of light receiving elements. In the light receiving device, each of the plurality of light receiving elements receives the second spatial light signal transmitted from the communication target. The light receiving device outputs a reception signal included in the second spatial light signal received by each of the plurality of light receiving elements to the communication control device. The communication control device includes a condition storage unit, a light transmission condition generation unit, a light transmission control unit, a signal acquisition unit, a signal analysis unit, and a signal generation unit. The light transmission condition generation unit generates a light transmission condition for transmitting the spatial light signal based on the condition stored in the condition storage unit. The light transmission condition generation unit generates a light transmission condition for transmitting the spatial light signal (first spatial light signal) including the transmission signal toward the address (first address) in the transmission coordinate system (first transmission coordinate system) set in the host device according to the transmission signal generated by the signal generation unit. The light transmission control unit controls the light transmitting device in such a way as to transmit the spatial light signal based on the light transmission condition generated by the light transmission condition generation unit. The signal acquisition unit acquires a reception signal included in the spatial light signal from the light receiving device that has received the spatial light signal (second spatial light signal) transmitted from the communication target. The signal analysis unit analyzes the reception signal acquired by the signal acquisition unit, and extracts an address (second address) of the communication target in the transmission coordinate system (second transmission coordinate system) included in the reception signal. The signal generation unit generates a transmission signal including an address (first address) of a light transmission destination of the spatial light signal (first spatial light signal) transmitted from the host device. The signal generation unit generates a transmission signal including the first address and the second address according to an analysis result of the reception signal included in the spatial light signal (second spatial light signal) transmitted from the communication target. The signal generation unit outputs the generated transmission signal to the light transmission condition generation unit.

The communication device of the present example embodiment can simultaneously receive the spatial light signals transmitted from the plurality of communication targets with the plurality of light receiving elements. Therefore, according to the communication device of the present example embodiment, communication can be established simultaneously with a plurality of communication targets.

In an aspect of the present example embodiment, the signal generation unit generates a transmission signal including an identifier of the host device. According to the present aspect, by transmitting the first spatial light signal including the transmission signal including the identifier of the host device, the communication target can recognize that the light transmission source of the first spatial light signal is the host device based on the identifier included in the first spatial light signal. Similarly, according to the present aspect, by receiving the second spatial light signal including the transmission signal including the identifier of the communication target, it is possible to identify the communication target of the light transmission source of the second spatial light signal based on the identifier included in the second spatial light signal.

In an aspect of the present example embodiment, the signal generation unit generates a transmission signal including information in which identifier of each of the plurality of communication targets is associated with a first address and a second address related to each of the plurality of communication targets according to reception of the second spatial light signals transmitted from the plurality of communication targets. The light transmission condition generation unit generates a light transmission condition for transmitting the first spatial light signal including the transmission signal toward the first address related to each of the plurality of communication targets included in the transmission signal according to the transmission signal. The light transmission control unit controls the light transmitting device in such a way as to transmit the first spatial light signal toward the first address related to each of the plurality of communication targets based on the light transmission condition. In the present aspect, a transmission signal in which identifier of each of a plurality of communication targets is associated with a first address and a second address related to each of the plurality of communication targets is generated. According to the present aspect, more accurate spatial light communication can be achieved by clarifying for which communication target the transmission signal is based on the identifier of the transmission signal included in the spatial light signal.

### Third Example Embodiment

Next, a communication device according to a third example embodiment will be described with reference to the drawings. The communication device of the present example embodiment is different from that of each of the first to second example embodiments in that it includes a plurality of light sources.

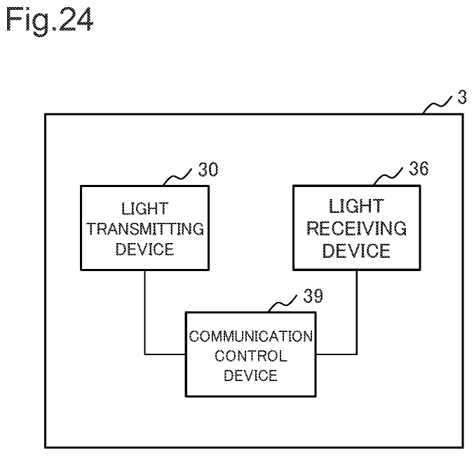

FIG. 24 is a block diagram illustrating an example of a configuration of a communication device 3 of the present example embodiment. The communication device 3 of the present example embodiment includes a light transmitting device 30, a light receiving device 36, and a communication control device 39. The light receiving device 36 has a configuration similar to any of the light receiving devices of the first to second example embodiments. When the light receiving device 36 has a configuration similar to that of the light receiving device 16 of the first example embodiment, the communication control device 39 has a configuration similar to that of the communication control device 19 of the first example embodiment. When the light receiving device 36 has a configuration similar to that of the light receiving device 26 of the second example embodiment, the communication control device 39 has a configuration similar to that of the communication control device 29 of the second example embodiment. Hereinafter, the description of the light receiving device 36 and the communication control device 39 will be omitted, and the configuration of the light transmitting device 20 will be described in detail.

### [Light Transmitting Device]

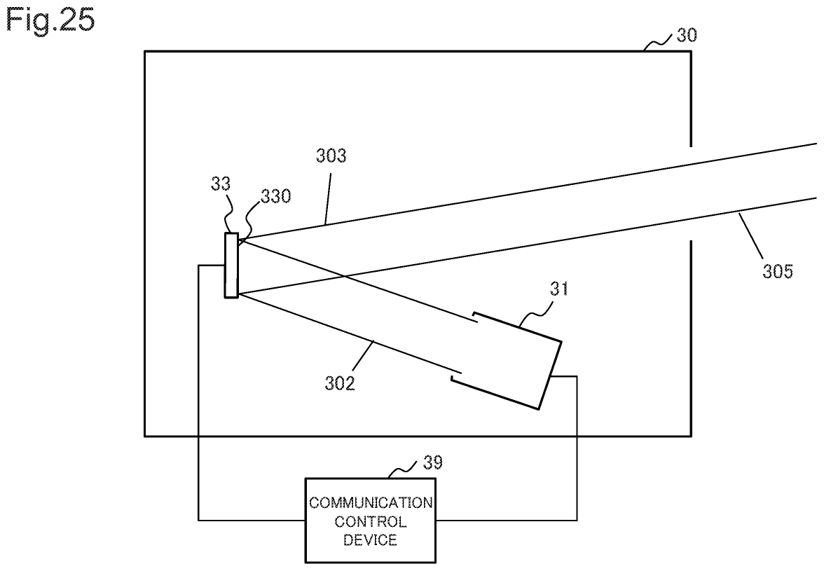

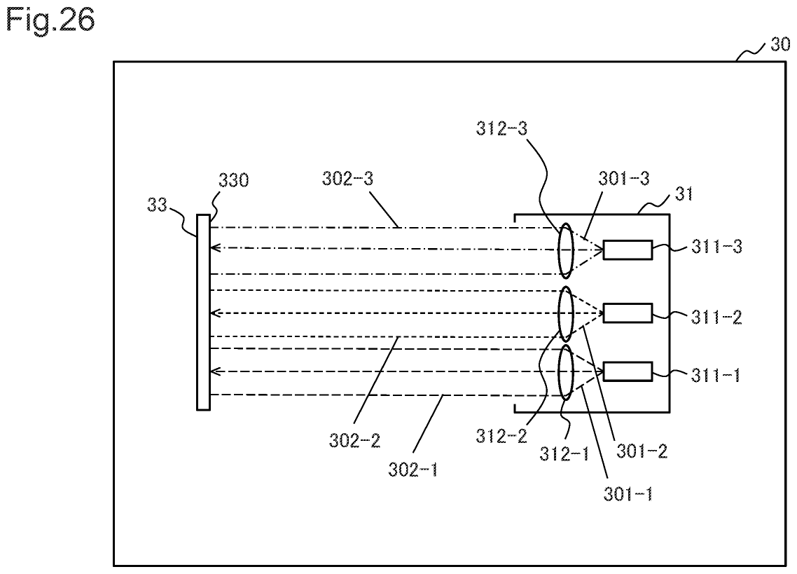

A configuration of the light transmitting device 30 will be described with reference to the drawings. FIGS. 25 to 26 are conceptual diagrams illustrating an example of a configuration of the light transmitting device 20. The light transmitting device 20 includes a light source 31 and a spatial light modulator 33. FIG. 25 is a side view of the internal configuration of the light transmitting device 20 when viewed from the lateral direction. FIG. 26 is a top view of the internal configuration of the light transmitting device 20 when viewed from above. FIGS. 25 to 26 are conceptual, and do not accurately represent the positional relationship between the components, the traveling direction of light, and the like.

The light source 31 includes a plurality of light emitters 311-1 to 3 and a plurality of lenses 312-1 to 3. The plurality of light emitters 311-1 to 3 is disposed in such a way that the emission axes do not cross each other in the optical path to the spatial light modulator 33. In the present example embodiment, an example in which the light source 31 includes three light emitters 311 and three lenses 312 will be described. Each of the number of the light emitters 311 and the number of the lenses 312 included in the light source are not limited to three.

Each of the plurality of light emitters 311-1 to 3 has a configuration similar to that of the light emitter 111 of the first example embodiment. The plurality of light emitters 311-1 to 3 emits laser beams 301-1 to 3, respectively, in a predetermined wavelength band under the control of the communication control device 39. The plurality of light emitters 311-1 to 3 may be configured to emit laser beams 301-1 to 3 in the same wavelength band, or may be configured to emit laser beams 301-1 to 3 of different wavelength bands. The plurality of light emitters 311-1 to 3 may have the same output or different outputs. The wavelength bands and outputs of the laser beams 301-1 to 3 emitted from the plurality of light emitters 311-1 to 3, respectively, may be selected according to the application.

A first modulation region related to the light emitter 311-1, a second modulation region related to the light emitter 311-2, and a third modulation region related to the light emitter 311-3 are set in a modulation part 330 of the spatial light modulator 33. The lens 312-1 is disposed in such a way that the laser beam 301-1 emitted from the light emitter 311-1 is radiated in accordance with the size of the first modulation region set in the modulation part 330. The lens 312-2 is disposed in such a way that the laser beam 301-2 emitted from the light emitter 311-2 is radiated in accordance with the size of the second modulation region set in the modulation part 330. The lens 312-3 is disposed in such a way that the laser beam 301-3 emitted from the light emitter 311-3 is radiated in accordance with the size of the third modulation region set in the modulation part 330. The radiation ranges of the laser beams 301-1 to 3 emitted from the plurality of light emitters 311-1 to 3 are adjusted by the plurality of lenses 312-1 to 3, and the laser beams are emitted from the light source 31. The light 302-1 to 3 emitted from the light source 31 travels toward the modulation part 330 of the spatial light modulator 33.

The spatial light modulator 33 has a configuration similar to that of the spatial light modulator 13 of the first example embodiment. The spatial light modulator 33 includes the modulation part 330. A modulation region related to the number of the light emitters 311 is set in the modulation part 330 of the spatial light modulator 33. In the present example embodiment, a first modulation region related to the light emitter 311-1, a second modulation region related to the light emitter 311-2, and a third modulation region related to the light emitter 311-3 are set in the modulation part 330 of the spatial light modulator 33. The first modulation region is irradiated with the laser beam 301-1 emitted from the light emitter 311-1. The second modulation region is irradiated with the laser beam 301-2 emitted from the light emitter 311-2. The third modulation region is irradiated with the laser beam 301-3 emitted from the light emitter 311-3.

Each of the plurality of modulation regions allocated to the modulation part 330 of the spatial light modulator 33 is divided into a plurality of regions (also referred to as tiling). For example, each of the plurality of regions allocated to the modulation part 330 is divided into rectangular regions (also referred to as tiles) having a desired aspect ratio. Each of the plurality of tiles includes a plurality of pixels. A phase image is assigned to each of the plurality of tiles set in each of the plurality of modulation regions. A phase image is tiled to each of the plurality of tiles allocated to the modulation part 330. For example, a phase image generated in advance is set in each of the plurality of tiles. A phase image related to an image to be projected is set to each of the plurality of tiles. When the modulation part 330 is irradiated with the light 302 in a state where the phase images are set for the plurality of tiles, the modulated light 303 that forms an image related to the phase image of each tile is emitted.

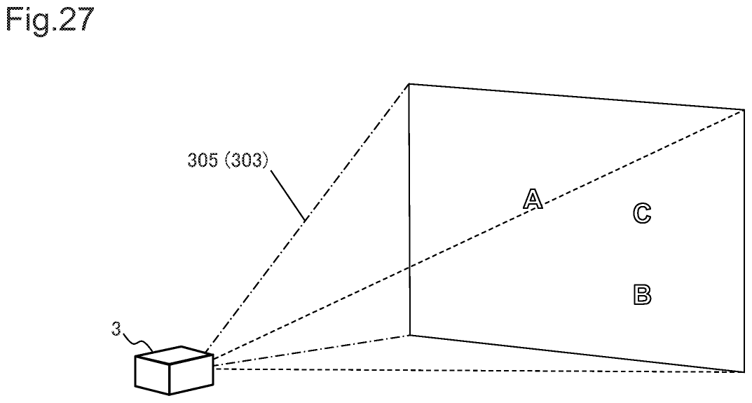

FIG. 27 is a conceptual diagram illustrating a projection example of modulated light 303 (projection light 305) modulated by the modulation part 330 of the spatial light modulator 33. The modulated light 303 modulated by the modulation part 330 is projected as the projection light 305. The projection light 305 displays an image related to the phase image set in the modulation part 330 of the spatial light modulator 33 at an any position on the face to be projected. As illustrated in FIG. 27, since the light source 31 includes the plurality of light emitters 311-1 to 3, an image can be displayed at an any position in the same image region.

For example, the modulated light 303 modulated by the modulation part 330 of the spatial light modulator 33 may be projected after being reflected by a reflecting mirror (not illustrated). For example, when a reflecting mirror (also referred to as a curved surface mirror) having a curved reflecting surface is used, the modulated light 303 can be enlarged and projected. The light (projection light 305) reflected by the reflecting surface of the curved surface mirror is enlarged at an enlargement ratio related to the curvature of the reflecting surface and projected. For example, a reflecting mirror (also referred to as a planar mirror) having a planar reflecting surface may be used. The reflecting mirror may be configured by combining a plurality of curved surface mirrors or a plurality of flat mirrors. The form and the number of reflecting mirrors are not particularly limited.

For example, a shielder (not illustrated) may be disposed on the optical path of the modulated light 303. The shielder is disposed on an optical path of the modulated light 303 modulated by the modulation part 330 of the spatial light modulator 33. For example, the shielder is a frame that shields unnecessary light components included in the modulated light 303 and defines the outer edge of the display region of the projection light 305. For example, the shielder is an aperture in which a slit-shaped opening is formed in a portion through which light forming a desired image passes. The shielder transmits light that forms a desired image and shields unwanted light components. For example, the shielder shields 0th-order light or a ghost image included in the modulated light 303.

For example, a 0th-order light removal element (not illustrated) may be disposed on the optical path of the modulated light 303. The 0th-order light shielding element is an element in which a portion that absorbs/reflects light is formed. The 0th-order light shielding element is disposed on an optical path of the 0th-order light. For example, a transparent element such as glass having a portion painted black so as not to transmit light can be used as the 0th-order light shielding element.

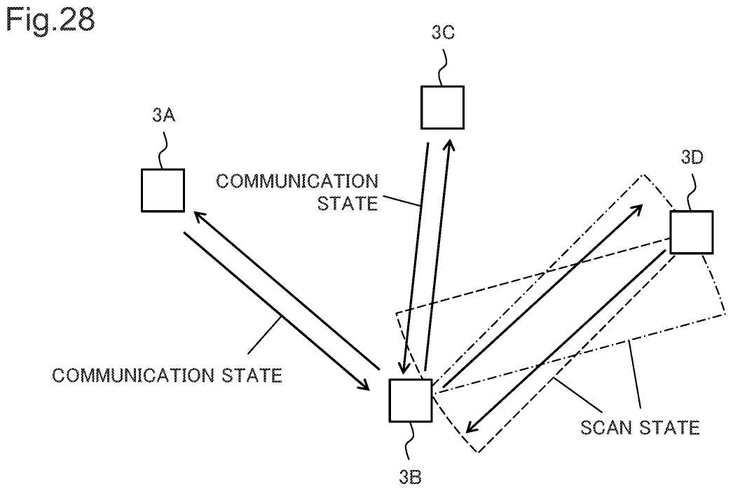

FIG. 28 is a conceptual diagram illustrating an example of a communication network including a plurality of communication devices 3. The communication network of FIG. 28 includes four communication devices 3 (communication device 3A, communication device 3B, communication device 3C, and communication device 3D). Since the light source 31 included in the communication device 3 includes the plurality of light emitters 311-1 to 3, a spatial light signal can be projected at an any position in the same projection region. Therefore, since the communication device 3 includes the plurality of light emitters 311-1 to 3, it is possible to transmit independent spatial light signals to the communication device 3A, the communication device 3B, and the communication device 3C. In the example of FIG. 28, each of the plurality of light emitters 311-1 to 3 included in the communication device 3B is allocated to communication with each of the communication device 3A, the communication device 3B, and the communication device 3C. In the example of FIG. 28, the communication device 3B scans the communication device 3D while maintaining the communication state with the communication device 3A and the communication device 3C. In this manner, the communication device 3 can establish communication independently with each of the plurality of communication targets.

As described above, the communication device of the present example embodiment includes the light transmitting device, the light receiving device, and the control device. The light transmitting device includes a plurality of light sources. The light transmitting device transmits a spatial light signal (first spatial light signal) from each of the plurality of light sources according to the control of the communication control device. The light receiving device receives a spatial light signal (second spatial light signal) transmitted from the communication target. The light receiving device outputs a reception signal included in the received second spatial light signal to the communication control device. The communication control device includes a condition storage unit, a light transmission condition generation unit, a light transmission control unit, a signal acquisition unit, a signal analysis unit, and a signal generation unit. The light transmission condition generation unit generates a light transmission condition for transmitting the spatial light signal based on the condition stored in the condition storage unit. The light transmission condition generation unit generates a light transmission condition for transmitting the spatial light signal (first spatial light signal) including the transmission signal toward the address (first address) in the transmission coordinate system (first transmission coordinate system) set in the host device according to the transmission signal generated by the signal generation unit. The light transmission control unit controls the light transmitting device in such a way as to transmit the spatial light signal based on the light transmission condition generated by the light transmission condition generation unit. The signal acquisition unit acquires a reception signal included in the spatial light signal from the light receiving device that has received the spatial light signal (second spatial light signal) transmitted from the communication target. The signal analysis unit analyzes the reception signal acquired by the signal acquisition unit, and extracts an address (second address) of the communication target in the transmission coordinate system (second transmission coordinate system) included in the reception signal. The signal generation unit generates a transmission signal including an address (first address) of a light transmission destination of the spatial light signal (first spatial light signal) transmitted from the host device. The signal generation unit generates a transmission signal including the first address and the second address according to an analysis result of the reception signal included in the spatial light signal (second spatial light signal) transmitted from the communication target. The signal generation unit outputs the generated transmission signal to the light transmission condition generation unit.

The communication device of the present example embodiment can simultaneously transmit spatial light signals to a plurality of communication targets by a plurality of light sources. Therefore, according to the communication device of the present example embodiment, communication can be established simultaneously with a plurality of communication targets.

In an aspect of the present example embodiment, the communication control device controls each of the plurality of light sources in such a way that the first spatial light signal for scanning the communication target and the first spatial light signal for communication with the communication target for which communication is established are independently transmitted from each of the plurality of light sources included in the light transmitting device. According to the present aspect, scanning of a communication target and communication with a communication target for which communication has been established can be performed simultaneously.

In an aspect of the present example embodiment, the signal generation unit generates a transmission signal including an identifier of the host device. According to the present aspect, by transmitting the first spatial light signal including the transmission signal including the identifier of the host device, the communication target can recognize that the light transmission source of the first spatial light signal is the host device based on the identifier included in the first spatial light signal. Similarly, according to the present aspect, by receiving the second spatial light signal including the transmission signal including the identifier of the communication target, it is possible to identify the communication target of the light transmission source of the second spatial light signal based on the identifier included in the second spatial light signal.

In an aspect of the present example embodiment, the signal generation unit generates a transmission signal including information in which identifier of each of the plurality of communication targets is associated with a first address and a second address related to each of the plurality of communication targets according to reception of the second spatial light signals transmitted from the plurality of communication targets. The light transmission condition generation unit generates a light transmission condition for transmitting the first spatial light signal including the transmission signal toward the first address related to each of the plurality of communication targets included in the transmission signal according to the transmission signal. The light transmission control unit controls the light transmitting device in such a way as to transmit the first spatial light signal toward the first address related to each of the plurality of communication targets based on the light transmission condition. In the present aspect, a transmission signal in which identifier of each of a plurality of communication targets is associated with a first address and a second address related to each of the plurality of communication targets is generated. According to the present aspect, more accurate spatial light communication can be achieved by clarifying for which communication target the transmission signal is based on the identifier of the transmission signal included in the spatial light signal.

### Fourth Example Embodiment

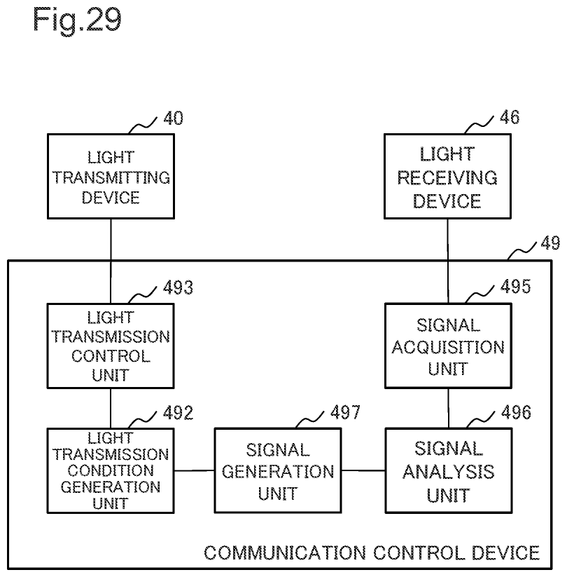

Next, a communication control device according to the fourth example embodiment will be described with reference to the drawings. The communication control device of the present example embodiment has a configuration in which the communication control device of each of the first to third example embodiments is simplified. FIG. 29 is a block diagram illustrating an example of a configuration of a communication control device 49 according to the present example embodiment. The communication control device 49 includes a light transmission condition generation unit 492, a light transmission control unit 493, a signal acquisition unit 495, a signal analysis unit 496, and a signal generation unit 497. The communication control device 49 controls a light transmitting device 40 that transmits the first spatial light signal and a light receiving device 46 that receives the second spatial light signal transmitted from the communication target.

The light transmission condition generation unit 492 generates a light transmission condition for transmitting the first spatial light signal including the transmission signal toward the first address in the first transmission coordinate system according to the transmission signal. The light transmission control unit 493 controls the light transmitting device 40 in such a way as to transmit the first spatial light signal toward the first address based on the light transmission condition. The signal acquisition unit 495 acquires a reception signal included in the second spatial light signal from the light receiving device 46 that has received the second spatial light signal. The signal analysis unit 496 analyzes the reception signal acquired by the signal acquisition unit 495 and extracts the second address in the second transmission coordinate system included in the reception signal. The signal generation unit 497 generates a transmission signal including the first address, and generates a transmission signal including the first address and the second address according to an analysis result of the reception signal. The signal generation unit 497 outputs the generated transmission signal to the light transmission condition generation unit 492.

As described above, the communication control device of the present example embodiment can accurately grasp the positions of the communication device (host device) and the communication target by exchanging the addresses of the light transmission destinations of the spatial light signals of the communication device and the communication target in the transmission coordinate system between the host device and the communication target. In the communication control device of the present example embodiment, it is not necessary for the host device and the communication target to operate cooperatively, and it is not necessary to use an image or the like. Therefore, according to the communication control device of the present example embodiment, communication with the communication target can be established in an any situation.

### (Hardware)

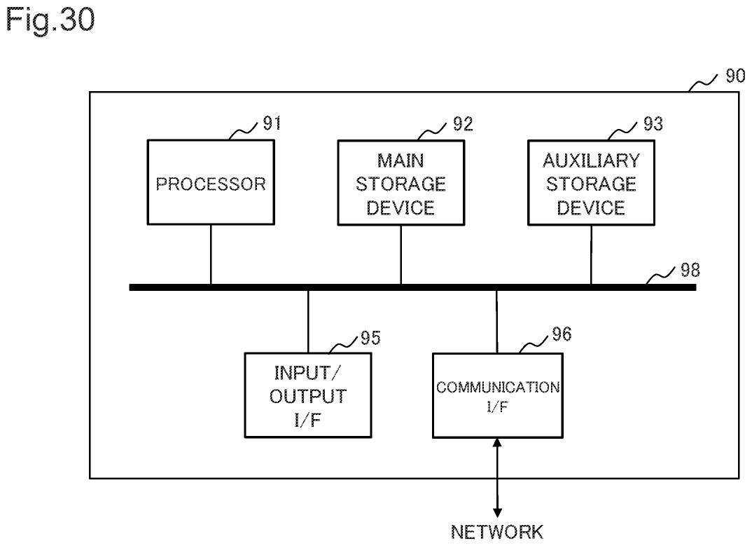

A hardware configuration for executing control and processing according to each example embodiment of the present disclosure will be described using an information processing device 90 of FIG. 30 as an example. The information processing device 90 in FIG. 30 is a configuration example for performing control and a process of each example embodiment, and does not limit the scope of the present disclosure.

As illustrated in FIG. 30, the information processing device 90 includes a processor 91, a main storage device 92, an auxiliary storage device 93, an input/output interface 95, and a communication interface 96. In FIG. 30, the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops the program stored in the auxiliary storage device 93 or the like in the main storage device 92. The processor 91 executes the program developed in the main storage device 92. In the present example embodiment, a software program installed in the information processing device 90 may be used. The processor 91 executes control and processing according to each example embodiment.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). A nonvolatile memory such as a magnetoresistive random access memory (MRAM) may be configured and added as the main storage device 92.

The auxiliary storage device 93 stores various pieces of data such as programs. The auxiliary storage device 93 is achieved by a local disk such as a hard disk or a flash memory. Various pieces of data may be stored in the main storage device 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input of information and settings. In a case where the touch panel is used as the input device, the display screen of the display equipment may also serve as the interface of the input device. Data communication between the processor 91 and the input device may be mediated by the input/output interface 95.

The information processing device 90 may be provided with the display equipment that displays information. In a case where the display equipment is provided, the information processing device 90 preferably includes a display control device (not illustrated) that controls display of the display equipment. The display equipment may be connected to the information processing device 90 via the input/output interface 95.

The information processing device 90 may be provided with a drive device. The drive device mediates reading of data and a program from the recording medium, writing of a processing result of the information processing device 90 to the recording medium, and the like between the processor 91 and the recording medium (program recording medium). The drive device may be connected to the information processing device 90 via the input/output interface 95.

The above is an example of a hardware configuration for enabling control and processing according to each example embodiment of the present invention. The hardware configuration of FIG. 30 is an example of a hardware configuration for executing control and processing according to each example embodiment, and does not limit the scope of the present invention. A program for causing a computer to execute control and processing according to each example embodiment is also included in the scope of the present invention. A program recording medium in which the program according to each example embodiment is recorded is also included in the scope of the present invention. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. The recording medium may be achieved by a magnetic recording medium such as a flexible disk, or another recording medium. In a case where the program executed by the processor is recorded in the recording medium, the recording medium corresponds to a program recording medium.

The components of each example embodiment may be combined in any manner. The components of each example embodiment may be achieved by software or may be achieved by a circuit.

While the present invention is described with reference to example embodiments thereof, the present invention is not limited to these example embodiments. Various modifications that can be understood by those of ordinary skill in the art can be made to the configuration and details of the present invention within the scope of the present invention.

Some or all of the above example embodiments may be described as the following Supplementary Notes, but are not limited to the following.

### (Supplementary Note 1)

A communication control device that controls a light transmitting device transmitting a first spatial light signal and a light receiving device receiving a second spatial light signal transmitted from a communication target, the communication control device including
a light transmission condition generation unit that generates, according to a transmission signal, a light transmission condition for transmitting the first spatial light signal including the transmission signal toward a first address in a first transmission coordinate system,
a light transmission control unit that controls the light transmitting device in such a way as to transmit the first spatial light signal toward the first address based on the light transmission condition,
a signal acquisition unit that acquires a reception signal included in the second spatial light signal from the light receiving device that has received the second spatial light signal,
a signal analysis unit that analyzes the reception signal acquired by the signal acquisition unit and extracts a second address in a second transmission coordinate system, the second address being included in the reception signal, and
a signal generation unit that generates the transmission signal including the first address, generate the transmission signal including the first address and the second address according to a result of analyzing the reception signal, and output the generated transmission signal to the light transmission condition generation unit.

### (Supplementary Note 2)

The communication control device according to Supplementary Note 1, wherein
the signal generation unit
generates the transmission signal in which a position of the first address has been sequentially changed within a range of a scan area in which the first transmission coordinate system is set, in a scan mode in which the communication target is searched for,
the light transmission condition generation unit
generates, according to the transmission signal, the light transmission condition for transmitting the first spatial light signal including the transmission signal toward the first address whose position is sequentially changed within a range of the scan area, and
the light transmission control unit
controls the light transmitting device in such a way as to change a light transmission direction of the first spatial light signal for searching for the communication target by sequentially changing the position of the first address within a range of the scan area.

### (Supplementary Note 3)

The communication control device according to Supplementary Note 1 or 2, wherein
the signal generation unit
generates a first transmission signal including the first address in the first transmission coordinate system,
the light transmission condition generation unit
generates a first light transmission condition for transmitting a primary scan signal that is the first spatial light signal including the first transmission signal toward the first address according to the first transmission signal, and
the light transmission control unit
controls the light transmitting device in such a way as to transmit the primary scan signal toward the first address based on the first light transmission condition.

### (Supplementary Note 4)

The communication control device according to Supplementary Note 3, wherein
the signal generation unit
generates, according to reception of the primary scan signal transmitted from the communication target, a second transmission signal including the second address in the second transmission coordinate system and the first address in the first transmission coordinate system, the second address being included in the primary scan signal transmitted from the communication target,
the light transmission condition generation unit
generates a second light transmission condition for transmitting a secondary scan signal that is the first spatial light signal including the second transmission signal toward the first address according to the second transmission signal, and
the light transmission control unit
controls the light transmitting device in such a way as to transmit the secondary scan signal toward the first address based on the second light transmission condition.

### (Supplementary Note 5)

The communication control device according to Supplementary Note 4, wherein
the signal generation unit
generates, according to reception of the secondary scan signal transmitted from the communication target, a third transmission signal including the second address in the second transmission coordinate system and the first address in the first transmission coordinate system, the second address being included in the secondary scan signal transmitted from the communication target,
the light transmission condition generation unit
generates a third light transmission condition for transmitting a primary communication establishment signal that is the first spatial light signal including the third transmission signal toward the first address according to the third transmission signal, and
the light transmission control unit
controls the light transmitting device in such a way as to transmit the primary communication establishment signal toward the first address based on the third light transmission condition.

### (Supplementary Note 6)

The communication control device according to Supplementary Note 5, wherein
the signal generation unit
generates, according to reception of the primary communication establishment signal transmitted from the communication target, a fourth transmission signal including the second address in the second transmission coordinate system and the first address in the first transmission coordinate system, the second address being included in the primary communication establishment signal transmitted from the communication target,
the light transmission condition generation unit
generates a fourth light transmission condition for transmitting a secondary communication establishment signal that is the first spatial light signal including the fourth transmission signal toward the first address according to the fourth transmission signal, and
the light transmission control unit
controls the light transmitting device in such a way as to transmit the secondary communication establishment signal toward the first address based on the fourth light transmission condition.

### (Supplementary Note 7)

The communication control device according to any one of Supplementary Notes 1 to 6, wherein
the signal analysis unit
calculates a center of gravity of the second addresses in the second transmission coordinate system, the second addresses being included in the second spatial light signals received a plurality of times according to a plurality of times of reception of the second spatial light signals within a predetermined period,
the signal generation unit
generates the transmission signal including the first address in the first transmission coordinate system, the first address being included in the second spatial light signal, and a center of gravity of the second addresses,
the light transmission condition generation unit
generates, according to the transmission signal, the light transmission condition for transmitting the first spatial light signal including the transmission signal toward the first address included in the transmission signal, and
the light transmission control unit
controls the light transmitting device in such a way as to transmit the first spatial light signal toward the first address based on the light transmission condition.

### (Supplementary Note 8)

The communication control device according to Supplementary Note 7, wherein
the signal generation unit
generates, according to reception of the second spatial light signal including a center of gravity of the first address, the transmission signal including the second address in the second transmission coordinate system and the center of gravity of the first address, the second address being included in the second spatial light signal,
the light transmission condition generation unit
generates, according to the transmission signal, the light transmission condition for transmitting the first spatial light signal including the transmission signal toward the center of gravity of the first address in the first transmission coordinate system, and
the light transmission control unit
controls the light transmitting device in such a way as to transmit the first spatial light signal toward the center of gravity of the first address based on the light transmission condition.

### (Supplementary Note 9)

The communication control device according to any one of Supplementary Notes 1 to 6, wherein
the signal generation unit
generates, according to a single reception of the second spatial light signal within a predetermined period, the transmission signal including a request to narrow down a light transmission direction of the second spatial light signal with the second address included in the received second spatial light signal as a center, the first address in the first transmission coordinate system, the first address being included in the second spatial light signal, and the second address of the received second spatial light signal,
the light transmission condition generation unit
generates, according to the transmission signal, the light transmission condition for transmitting the first spatial light signal including the transmission signal toward the first address included in the transmission signal, and
the light transmission control unit
controls the light transmitting device in such a way as to transmit the first spatial light signal toward the first address based on the light transmission condition.

### (Supplementary Note 10)

The communication control device according to any one of Supplementary Notes 1 to 9, wherein
the signal generation unit
generates the transmission signal including an identifier of the communication control device.

### (Supplementary Note 11)

The communication control device according to Supplementary Note 10, wherein
the signal generation unit
generates, according to reception of the second spatial light signals transmitted from a plurality of the communication targets, the transmission signal including information in which the identifier of each of the plurality of communication targets is associated with the first address and the second address related to each of the plurality of communication targets,
the light transmission condition generation unit
generates, according to the transmission signal, the light transmission condition for transmitting the first spatial light signal including the transmission signal toward the first address related to each of the plurality of communication targets included in the transmission signal, and
the light transmission control unit
controls the light transmitting device in such a way as to transmit the first spatial light signal toward the first address related to each of the plurality of communication targets based on the light transmission condition.

### (Supplementary Note 12)

A communication device including
the communication control device according to any one of Supplementary Notes 1 to 11,
a light transmitting device that transmits a first spatial light signal under control of the communication control device, and
a light receiving device that receives a second spatial light signal transmitted from a communication target to output a reception signal included in the received second spatial light signal to the communication control device.

### (Supplementary Note 13)

The communication device according to Supplementary Note 12, wherein
the light receiving device
includes a plurality of light receiving elements, and
the communication control device
acquires the reception signal derived from the second spatial light signal received by the plurality of light receiving elements.

### (Supplementary Note 14)

The communication device according to Supplementary Note 12 or 13, wherein
the light transmitting device
includes a plurality of light sources, and
the communication control device
controls each of the plurality of light sources in such a way that the first spatial light signal is transmitted from each of the plurality of light sources included in the light transmitting device.

### (Supplementary Note 15)

The communication device according to Supplementary Note 12 or 13, wherein
the communication control device
controls each of the plurality of light sources in such a way that the first spatial light signal for scanning the communication target and the first spatial light signal for communication with the communication target for which communication is established are independently transmitted from each of the plurality of light sources included in the light transmitting device.

### (Supplementary Note 16)

A communication control method of controlling a light transmitting device transmitting a first spatial light signal and a light receiving device receiving a second spatial light signal transmitted from a communication target, the method executed by a computer including
generating, according to a transmission signal, a light transmission condition for transmitting the first spatial light signal including the transmission signal toward a first address in a first transmission coordinate system,
controlling the light transmitting device in such a way as to transmit the first spatial light signal toward the first address based on the light transmission condition,
acquiring a reception signal included in the second spatial light signal from the light receiving device that has received the second spatial light signal,
extracting a second address in a second transmission coordinate system, the second address being included in the reception signal, by analyzing the acquired reception signal, and
generating the transmission signal including the first address and generating the transmission signal including the first address and the second address according to a result of analyzing the reception signal.

### (Supplementary Note 17)

A program for controlling a light transmitting device transmitting a first spatial light signal and a light receiving device receiving a second spatial light signal transmitted from a communication target, the program for causing a computer to execute the processing of
generating, according to a transmission signal, a light transmission condition for transmitting the first spatial light signal including the transmission signal toward a first address in a first transmission coordinate system,
controlling the light transmitting device in such a way as to transmit the first spatial light signal toward the first address based on the light transmission condition,
acquiring a reception signal included in the second spatial light signal from the light receiving device that has received the second spatial light signal,
extracting a second address in a second transmission coordinate system, the second address being included in the reception signal, by analyzing the acquired reception signal, and
generating the transmission signal including the first address and generating the transmission signal including the first address and the second address according to a result of analyzing the reception signal.

### REFERENCE SIGNS LIST

1, 2, 3 communication device
10, 20, 30 light transmitting device
11 light source
13 spatial light modulator
16, 26, 36 light receiving device
17, 27 light receiving element
18, 28 reception circuit
19, 29, 39, 49 communication control device
111, 311 light emitter
112, 312 lens
161, 261 concentrator
191 condition storage unit
192, 492 light transmission condition generation unit
193, 493 light transmission control unit
195, 495 signal acquisition unit
196, 496 signal analysis unit
197, 497 signal generation unit
281 first processing circuit
282 control circuit
283 selector
285 second processing circuit

What is claimed is:

1. A communication control device that controls a light transmitting device transmitting a first spatial light signal and a light receiving device receiving a second spatial light signal transmitted from a communication target, the communication control device comprising:
a memory storing instructions; and
a processor connected to the memory and configured to execute the instructions to:
generate, according to a transmission signal, a light transmission condition for transmitting the first spatial light signal including the transmission signal toward a first address in a first transmission coordinate system;
control the light transmitting device in such a way as to transmit the first spatial light signal toward the first address based on the light transmission condition;
acquire a reception signal included in the second spatial light signal from the light receiving device that has received the second spatial light signal;
analyze the reception signal;
extract a second address in a second transmission coordinate system, the second address being included in the reception signal; and
generate the transmission signal including the first address; and
generate the transmission signal including the first address and the second address according to a result of analyzing the reception signal.

2. The communication control device according to claim 1, wherein
the processor is configured to execute the instructions to
generate the transmission signal in which a position of the first address has been sequentially changed within a range of a scan area in which the first transmission coordinate system is set, in a scan mode in which the communication target is searched for,
generate, according to the transmission signal, the light transmission condition for transmitting the first spatial light signal including the transmission signal toward the first address whose position is sequentially changed within a range of the scan area, and
control the light transmitting device in such a way as to change a light transmission direction of the first spatial light signal for searching for the communication target by sequentially changing a position of the first address within a range of the scan area.

3. The communication control device according to claim 1, wherein
the processor is configured to execute the instructions to
generate a first transmission signal including the first address in the first transmission coordinate system,
generate a first light transmission condition for transmitting a primary scan signal that is the first spatial light signal including the first transmission signal toward the first address according to the first transmission signal, and
control the light transmitting device in such a way as to transmit the primary scan signal toward the first address based on the first light transmission condition.

4. The communication control device according to claim 3, wherein
the processor is configured to execute the instructions to
generate, according to reception of the primary scan signal transmitted from the communication target, a second transmission signal including the second address in the second transmission coordinate system and the first address in the first transmission coordinate system, the second address being included in the primary scan signal transmitted from the communication target,
generate a second light transmission condition for transmitting a secondary scan signal that is the first spatial light signal including the second transmission signal toward the first address according to the second transmission signal, and
control the light transmitting device in such a way as to transmit the secondary scan signal toward the first address based on the second light transmission condition.

5. The communication control device according to claim 4, wherein
the processor is configured to execute the instructions to
generate, according to reception of the secondary scan signal transmitted from the communication target, a third transmission signal including the second address in the second transmission coordinate system and the first address in the first transmission coordinate system, the second address being included in the secondary scan signal transmitted from the communication target,
generate a third light transmission condition for transmitting a primary communication establishment signal that is the first spatial light signal including the third transmission signal toward the first address according to the third transmission signal, and
control the light transmitting device in such a way as to transmit the primary communication establishment signal toward the first address based on the third light transmission condition.

6. The communication control device according to claim 5, wherein
the processor is configured to execute the instructions to
generate, according to reception of the primary communication establishment signal transmitted from the communication target, a fourth transmission signal including the second address in the second transmission coordinate system and the first address in the first transmission coordinate system, the second address being included in the primary communication establishment signal transmitted from the communication target,
generate a fourth light transmission condition for transmitting a secondary communication establishment signal that is the first spatial light signal including the fourth transmission signal toward the first address according to the fourth transmission signal, and
control the light transmitting device in such a way as to transmit the secondary communication establishment signal toward the first address based on the fourth light transmission condition.

7. The communication control device according to claim 1, wherein
the processor is configured to execute the instructions to
calculate a center of gravity of the second addresses in the second transmission coordinate system, the second addresses being included in the second spatial light signals received a plurality of times according to a plurality of times of reception of the second spatial light signals within a predetermined period,
generate the transmission signal including the first address in the first transmission coordinate system, the first address being included in the second spatial light signal, and a center of gravity of the second addresses,
generate, according to the transmission signal, the light transmission condition for transmitting the first spatial light signal including the transmission signal toward the first address included in the transmission signal, and
control the light transmitting device in such a way as to transmit the first spatial light signal toward the first address based on the light transmission condition.

8. The communication control device according to claim 7, wherein
the processor is configured to execute the instructions to
generate, according to reception of the second spatial light signal including a center of gravity of the first address, the transmission signal including the second address in the second transmission coordinate system and the center of gravity of the first address, the second address being included in the second spatial light signal,
generate, according to the transmission signal, the light transmission condition for transmitting the first spatial light signal including the transmission signal toward the center of gravity of the first address in the first transmission coordinate system, and
control the light transmitting device in such a way as to transmit the first spatial light signal toward the center of gravity of the first address based on the light transmission condition.

9. The communication control device according to claim 1, wherein
the processor is configured to execute the instructions to
generate, according to a single reception of the second spatial light signal within a predetermined period, the transmission signal including a request to narrow down a light transmission direction of the second spatial light signal with the second address included in the received second spatial light signal as a center, the first address in the first transmission coordinate system, the first address being included in the second spatial light signal, and the second address of the received second spatial light signal,
generate, according to the transmission signal, the light transmission condition for transmitting the first spatial light signal including the transmission signal toward the first address included in the transmission signal, and
control the light transmitting device in such a way as to transmit the first spatial light signal toward the first address based on the light transmission condition.

10. The communication control device according to claim 1, wherein
the processor is configured to execute the instructions to
generate the transmission signal including an identifier of the communication control device.

11. The communication control device according to claim 10, wherein
the processor is configured to execute the instructions to
generate, according to reception of the second spatial light signals transmitted from a plurality of the communication targets, the transmission signal including information in which the identifier of each of the plurality of communication targets is associated with the first address and the second address related to each of the plurality of communication targets,
generate, according to the transmission signal, the light transmission condition for transmitting the first spatial light signal including the transmission signal toward the first address related to each of the plurality of communication targets included in the transmission signal, and
control the light transmitting device in such a way as to transmit the first spatial light signal toward the first address related to each of the plurality of communication targets based on the light transmission condition.

12. A communication device comprising:
the communication control device according to claim 1;
a light transmitting device that transmits a first spatial light signal under control of the communication control device; and
a light receiving device that receives a second spatial light signal transmitted from a communication target to output a reception signal included in the received second spatial light signal to the communication control device.

13. The communication device according to claim 12, wherein
the light receiving device
includes a plurality of light receiving elements, and
the processor of the communication control device is configured to execute the instructions to
acquire the reception signal derived from the second spatial light signal received by the plurality of light receiving elements.

14. The communication device according to claim 12, wherein
the light transmitting device
includes a plurality of light sources, and
the processor of the communication control device is configured to execute the instructions to
control each of the plurality of light sources in such a way that the first spatial light signal is transmitted from each of the plurality of light sources included in the light transmitting device.

15. The communication device according to claim 14, wherein
the processor of the communication control device is configured to execute the instructions to
control each of the plurality of light sources in such a way that the first spatial light signal for scanning the communication target and the first spatial light signal for communication with the communication target for which communication is established are independently transmitted from each of the plurality of light sources included in the light transmitting device.

16. A communication control method of controlling a light transmitting device transmitting a first spatial light signal and a light receiving device receiving a second spatial light signal transmitted from a communication target, the method executed by a computer comprising:
generating, according to a transmission signal, a light transmission condition for transmitting the first spatial light signal including the transmission signal toward a first address in a first transmission coordinate system;
controlling the light transmitting device in such a way as to transmit the first spatial light signal toward the first address based on the light transmission condition;
acquiring a reception signal included in the second spatial light signal from the light receiving device that has received the second spatial light signal;
extracting a second address in a second transmission coordinate system, the second address being included in the reception signal, by analyzing the acquired reception signal; and
generating the transmission signal including the first address and generating the transmission signal including the first address and the second address according to a result of analyzing the reception signal.

17. A non-transitory recording medium storing a program for controlling a light transmitting device transmitting a first spatial light signal and a light receiving device receiving a second spatial light signal transmitted from a communication target, the program for causing a computer to execute the processing of:
generating, according to a transmission signal, a light transmission condition for transmitting the first spatial light signal including the transmission signal toward a first address in a first transmission coordinate system;
controlling the light transmitting device in such a way as to transmit the first spatial light signal toward the first address based on the light transmission condition;
acquiring a reception signal included in the second spatial light signal from the light receiving device that has received the second spatial light signal;
extracting a second address in a second transmission coordinate system, the second address being included in the reception signal, by analyzing the acquired reception signal; and
generating the transmission signal including the first address and generating the transmission signal including the first address and the second address according to a result of analyzing the reception signal.
